(19) United States
(12) Patent Application Publication
(10) Pub. No.: US 2026/0340600 A1
(43) Pub. Date: Oct. 29, 2026

(54) SYSTEM AND METHOD FOR CHECK ROUTING BASED ON IDENTIFICATION DATA

(71) Applicant: Truist Bank, Charlotte, NC (US)

(72) Inventors: Jean Albuquerque, Charlotte, NC (US); Lindsay Delgrosso, US, NC (US); Shane Miller, Charlotte, NC (US); James Burby, Charlotte, NC (US)

(73) Assignee: Truist Bank, Charlotte, NC (US)

(21) Appl. No.: 19/188,731

(22) Filed: Apr. 24, 2025

(51) Int. Cl. G06Q 20/04; G06Q 40/02; G06V 30/413; G06V 30/416

(52) U.S. Cl. CPC G06Q 20/042; G06Q 40/02; G06V 30/413; G06V 30/416

(57) ABSTRACT

A server computing system for check processing includes a non-transitory memory coupled to one or more processors, and a set of instructions of computer-executable program code, which when executed by the one or more processors, cause the one or more processors to perform one or more operations including: analyzing image data associated with a check received by a merchant; identifying a check payment amount from the analyzed image data; analyzing customer account data associated with one or more customer accounts when the analyzed image data does not identify at least one of the one or more customer accounts; classifying the check, based on the identified payment amount and the analysis of the customer account data, as one classification type within a plurality of different classification types; identifying a check processing destination from a plurality of check processing destinations, based on the one classification type; generating a check processing destination message signal based on the check processing destination; and transmitting the check processing destination message signal to a client device to cause display of information related to the check processing destination on a user interface of the client device.

### TECHNICAL FIELD

Aspects of the present disclosure are generally related to systems and computer-implemented methods of routing a payment instrument such as a physical check.

### BACKGROUND

The current process for handling checks without clear identification information, such as those lacking account numbers or routing numbers, presents significant inefficiencies and security risks. These checks often lack the necessary information required for automated processing, leading to manual sorting and handling in the mailroom and various lines of business, including home loan and auto loan departments. This manual process can take up to two to three weeks, resulting in delays and potential misrouting of checks.

The inefficiencies in the current system not only prolong the processing time but also increase the likelihood of errors and misprocessing, which can have cascading effects on overall enterprise operations. Existing solutions address various aspects of financial transaction processing, including automated invoice capture, enhanced payment document generation, and correct check and electronic payment deposit processes. These solutions typically involve systems that integrate with loan origination systems, automatically gather and verify data, and manage underwriting criteria.

Additionally, there are methods for financing future purchases using future-dated checks or other payment instruments, which rely on the presenter's check writing history for verification. Other systems focus on determining the reliability of entities based on social connections and their reliability ratings, integrating with loan origination systems to facilitate the transfer of rights to loans between financial institutions. These solutions also include processes for recognizing and processing invoices, generating enhanced payment documents, and ensuring correct deposit of payments. Despite these advancements, the existing solutions do not adequately address the specific issue of handling checks without clear identification information. The reliance on manual sorting and processing introduces significant delays and security risks due to the handling of physical checks.

The inefficiencies in the current system highlight the need for a more streamlined and secure approach to processing checks that lack essential identification details. The existing solutions focus on automating various aspects of financial transactions but fail to provide a comprehensive solution for managing checks that require additional identification information for proper routing and processing. This gap in the current solutions underscores the need for a more robust and efficient method to handle such checks, thereby improving overall operational efficiency and reducing security risks associated with manual processing.

### SUMMARY

An aspect of the present disclosure is drawn to a server computing system for processing a payment instrument such as a physical check, the server computing system including: one or more processors; and a non-transitory memory, coupled to the one or more processors, having stored therein, customer account data associated with one or more accounts of a customer of an enterprise, and a set of instructions of computer-executable program code, which when executed by the one or more processors, cause the one or more processors to perform operations including: analyzing image data associated with an image of a check received by the enterprise; identifying a payment amount of the check from the analyzed image data; analyzing the customer account data when the analyzed image data does not identify at least one of the one or more customer accounts; classifying the check, based on the identified payment amount and the analysis of the customer account data, as one classification type within a plurality of different classification types; identifying a check processing destination, from a plurality of check processing destinations, based on the one classification type; generating a check processing destination message signal based on the check processing destination; and transmitting the check processing destination message signal to a client device to cause display of information related to the check processing destination on a user interface of the client device.

In one or more embodiments of this aspect, the set of instructions, which when executed by the one or more processors, cause the one or more processors to perform operations further including: identifying at least one due date, within the analyzed customer account data, associated with each one or more customer accounts, respectively; and identifying a candidate due date of the identified at least one due date, wherein the classifying the check as the one classification type within the plurality of different classification types is additionally based on the identified candidate due date. In one or more of these embodiments, the set of instructions, which when executed by the one or more processors, cause the one or more processors to perform operations further including: identifying a payment date on the check from the analyzed image data, wherein the classifying the check as the one classification type within the plurality of different classification types is additionally based on the payment date. In one or more of these embodiments, the set of instructions, which when executed by the one or more processors, cause the one or more processors to perform operations further including classifying the check as the one classification type within the plurality of different classification types when the payment date is prior to the identified candidate due date. In one or more of these embodiments, the set of instructions, which when executed by the one or more processors, cause the one or more processors to perform operations further including classifying the check as the one classification type within the plurality of different classification types when the payment date is within a predetermined threshold of days dₜₕ of the identified candidate due date.

In one or more embodiments of this aspect, the set of instructions, which when executed by the one or more processors, cause the one or more processors to perform operations further including: identifying at least one payment amount due, within the analyzed customer account data, associated with each one or more customer accounts, respectively; and identifying a candidate payment amount due of the identified at least one payment amount due, wherein the classifying the check as the one classification type within the plurality of different classification types is additionally based on the identified candidate payment amount due. In one or more of these embodiments, the set of instructions, which when executed by the one or more processors, cause the one or more processors to perform operations further including classifying the check as the one classification type within the plurality of different classification types when the payment amount is the same as the identified candidate payment amount due.

In one or more embodiments of this aspect, the set of instructions, which when executed by the one or more processors, cause the one or more processors to perform operations further including: identifying at least one payoff amount due, within the analyzed customer account data, associated with each one or more customer accounts, respectively; and identifying a candidate payoff amount due of the identified at least one payoff amount due, wherein the classifying the check as the one classification type within the plurality of different classification types is additionally based on the identified candidate payoff amount due. In one or more of these embodiments, the set of instructions, which when executed by the one or more processors, cause the one or more processors to perform operations further including classifying the check as the one classification type within the plurality of different classification types when the payment amount is the same as the identified candidate payoff amount due.

In one or more embodiments of this aspect, the set of instructions, which when executed by the one or more processors, cause the one or more processors to perform operations further including: identifying a name from the analyzed image data; identifying a name of the customer from the customer account data; and determining whether the name from the analyzed image data corresponds to the name of the customer. In one or more of these embodiments, the set of instructions, which when executed by the one or more processors, cause the one or more processors to perform operations further including: generating a return to sender signal when the name from the analyzed image data does not correspond to the name of the customer; and transmitting the return to sender signal to a client device to cause display of a return to sender message on a user interface of the client device. In one or more embodiments, the set of instructions, which when executed by the one or more processors, cause the one or more processors to perform operations further including identifying the name from a name data field portion of the analyzed image data. In one or more of these embodiments, the set of instructions, which when executed by the one or more processors, cause the one or more processors to perform operations further including: determining whether a second name is in a memo data field portion of the analyzed image data, when the name from the analyzed image data does not correspond to the name of the customer; identifying the second name when the second name is in the memo data field portion of the analyzed image data; and determining whether the second name from the analyzed image data corresponds to the name of the customer. In one or more of these embodiments, the set of instructions, which when executed by the one or more processors, cause the one or more processors to perform operations further including: generating a return to sender signal when the name from the analyzed image data does not correspond to the name of the customer, when the second name is not in the memo data field portion of the analyzed image data, and when the second name is in the memo data field portion of the analyzed data but does not correspond to the name of the customer; and transmitting the return to sender signal to a client device to cause display of a return to sender message on a user interface of the client device.

In one or more embodiments of this aspect, the set of instructions, which when executed by the one or more processors, cause the one or more processors to perform operations further including: identifying at least one due date, within the analyzed customer account data, associated with each one or more customer accounts, respectively; identifying a candidate due date of the identified at least one due date; identifying at least one payment amount due, within the analyzed customer account data, associated with each one or more customer accounts, respectively; and identifying a candidate payment amount due of the identified at least one payment amount due, wherein the classifying the check as the one classification type within the plurality of different classification types is additionally based on the identified candidate due date and the identified candidate payment amount due. In one or more of these embodiments, the set of instructions, which when executed by the one or more processors, cause the one or more processors to perform operations further including: identifying at least one payoff amount due, within the analyzed customer account data, associated with each one or more customer accounts, respectively; and identifying a candidate payoff amount due of the identified at least one payoff amount due, wherein the classifying the check as the one classification type within the plurality of different classification types is additionally based on the identified candidate payoff amount due.

Another aspect of the present disclosure is drawn a computer-implemented method of operating a system for implementation by a processor of a server computing system, the computer-implemented method including: analyzing image data associated with an image of a check received by an enterprise; identifying a payment amount of the check from the analyzed image data; analyzing customer account data when the analyzed image data does not identify at least one of one or more accounts of a customer; classifying the check, based on the identified payment amount and the analysis of the customer account data, as one classification type within a plurality of different classification types; identifying a check processing destination, from a plurality of check processing destinations, based on the one classification type; generating a check processing destination message signal based on the check processing destination; and transmitting the check processing destination message signal to a client device to cause display of information related to the check processing destination on a user interface of the client device. In one or more of these embodiments, the method further includes: identifying at least one payment amount due, within the analyzed customer account data, associated with each one or more customer accounts, respectively; and identifying a candidate payment amount due of the identified at least one payment amount due, wherein the classifying the check as the one classification type within the plurality of different classification types is additionally based on the identified candidate payment amount due.

Another aspect of the present disclosure is drawn to a computer program product comprising at least one non-transitory computer readable medium having a set of instructions of computer-executable program code, which when executed by one or more processors of an enterprise computer server system, cause the one or more processors to perform a computer-implemented method including: analyzing image data associated with an image of a check received by an enterprise; identifying a payment amount of the check from the analyzed image data; analyzing customer account data when the analyzed image data does not identify at least one of one or more accounts of a customer; classifying the check, based on the identified payment amount and the analysis of the customer account data, as one classification type within a plurality of different classification types; identifying a check processing destination, from a plurality of check processing destinations, based on the one classification type; generating a check processing destination message signal based on the check processing destination; and transmitting the check processing destination message signal to a client device to cause display of information related to the check processing destination on a user interface of the client device.

### DRAWINGS

The various advantages of the exemplary embodiments will become apparent to one skilled in the art by reading the following specification and appended claims, and by referencing the following drawings, in which:

FIG. 1 illustrates a communication environment in accordance with one or more embodiments set forth and described herein.

FIG. 2 illustrates a block diagram of the client device of FIG. 1.

FIG. 3 illustrates a block diagram of the one or more enterprise servers of FIG. 1.

FIG. 4 illustrates a block diagram of the data stores of the one or more servers of FIG. 3.

FIG. 5 illustrates a block diagram of the customers data storage of the data stores of FIG. 4.

FIG. 6 illustrates a block diagram of a customer product data portion of a customer data structure.

FIG. 7 illustrates a block diagram of the products data storage of the data stores of FIG. 4.

FIG. 8 illustrates a block diagram of an example enterprise having the one or more servers of FIG. 1.

FIG. 9A illustrates a portion of an example computer-implemented method of generating a check processing destination message for a check based on a check classification in accordance with aspects of the present disclosure.

FIG. 9B illustrates another portion of the example computer-implemented method of FIG. 9A.

FIG. 9C illustrates another portion of the example computer-implemented method of FIG. 9A.

FIG. 9D illustrates another portion of the example computer-implemented method of FIG. 9A.

FIG. 9E illustrates another portion of the example computer-implemented method of FIG. 9A.

FIG. 10 illustrates an image of a sample check layout and the different data fields therein.

FIG. 11A illustrates a block diagram of the enterprise user device of FIG. 8 receiving check data.

FIG. 11B illustrates a block diagram of the enterprise user device of FIG. 8 receiving a return to sender signal.

FIG. 11C illustrates a block diagram of the enterprise user device of FIG. 8 receiving a check processing destination message signal.

FIG. 11D illustrates a block diagram of the enterprise user device of FIG. 8 receiving a contact customer message signal.

FIG. 12 illustrates a block diagram of a portion of one or more enterprise servers of FIG. 3 for determining whether the obtained name corresponds to a customer of enterprise 800 in accordance with aspects of the present disclosure.

FIG. 13 illustrates a user interface of the enterprise user device of FIG. 11B displaying a return to sender message in accordance with aspects of the present disclosure.

FIG. 14 illustrates a block diagram of a portion of one or more enterprise servers of FIG. 3 for analyzing customer account data in accordance with aspects of the present disclosure.

FIG. 15 illustrates a block diagram of a portion of one or more enterprise servers of FIG. 3 for identifying products in accordance with aspects of the present disclosure in accordance with aspects of the present disclosure.

FIG. 16 illustrates a block diagram of a portion of one or more enterprise servers of FIG. 3 and an enterprise user device for transmitting a check processing destination message signal in accordance with aspects of the present disclosure.

FIG. 17 illustrates the user interface of the enterprise user device of FIG. 11C displaying a check processing destination message in accordance with aspects of the present disclosure.

FIG. 18 illustrates a block diagram of a portion of one or more enterprise servers of FIG. 3 and an enterprise user device for transmitting a contact customer message signal in accordance with aspects of the present disclosure.

FIG. 19 illustrates the user interface of the enterprise user device of FIG. 11D displaying a contact customer message in accordance with aspects of the present disclosure.

### DESCRIPTION

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user, including personal computers, laptops, tablets, and/or mobile smartphones.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programable gate array (FPGA) or an application specific integrated circuit (ASIC). A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein.

As used herein, “disk” or “disc” includes compact disc (CD), laser disc, optical disc, digital versatile disc (DVD), floppy disk and Blu-ray disc.

As used herein, “network” or “networks” relates to any combination of electronic communication networks, including without limitation the Internet, a local area network (LAN), a wide area network, a wireless network, and a cellular network (e.g., 4G, 5G).

As used herein, “input interface” relates to any device, software, component, system, element, or arrangement or groups thereof that enable information and/or data to be entered as input commands by a user in a manner that directs a processor to execute instructions.

As used herein, “output interface” relates to any device, software, component, system, element or arrangement or groups thereof that enable information/data to be presented to a user.

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “server” relates to a server computer or group of computers that acts to provide a service for a certain function or access to a network resource. A server may be a physical server, a hosted server in a virtual environment, or software code running on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a computer-implemented method, could be implemented as a series of software instructions for being operated by a processor, such that the embodiments could be implemented as software, hardware, or a combination thereof.

As used herein, “enterprise” is an institution that provides services and/or products to customers.

As used herein, “user” relates to a consumer, machine entity, and/or requesting party, and may be human or machine.

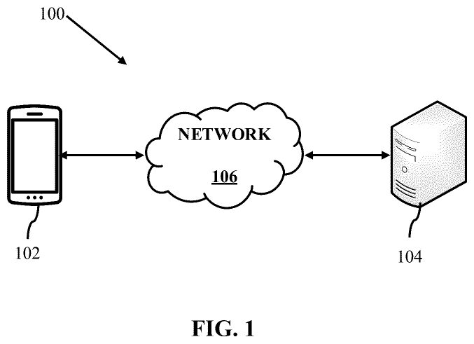

Turning to the figures, FIG. 1 illustrates a communication environment 100 in which a user communicates with an enterprise. A client device 102 operating in communication environment 100 facilitates user access to and user management of one or more user accounts residing at one or more enterprise servers 104. Communication environment 100 includes client device 102, one or more enterprise servers 104, and a communications network 106 through which communication is facilitated between client device 102 and one or more enterprise servers 104.

In accordance with one or more embodiments, client device 102 may take the form of a computing device, non-limiting examples of which include a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates client device 102 including any form of electronic device that optimizes the performance and functionality of the one or more embodiments in a manner that falls within the spirit and scope of the principles of this disclosure.

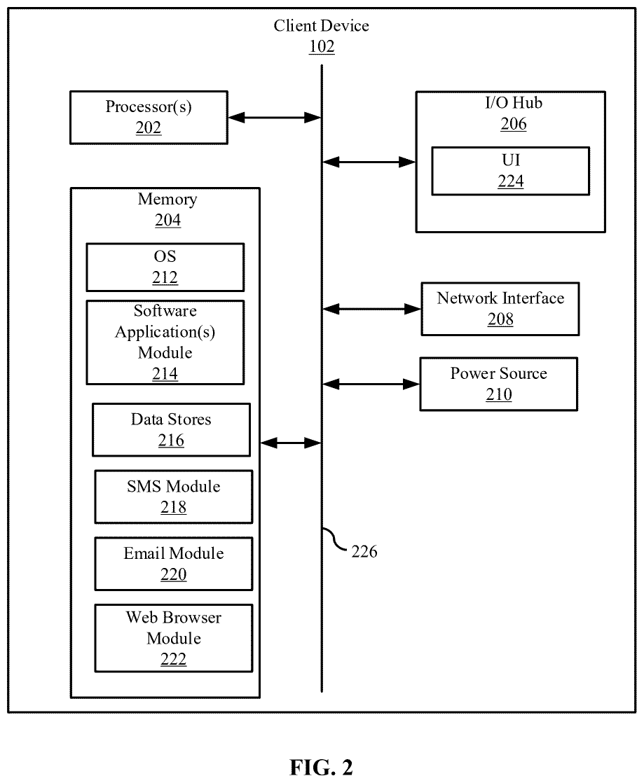

FIG. 2 illustrates a block diagram of client device 102. It will be understood that it is not necessary for client device 102 to have all the elements illustrated in FIG. 2. For example, client device 102 may have any combination of the various elements illustrated in FIG. 2. Moreover, client device 102 may have additional elements to those illustrated in FIG. 2.

As shown in the figure, client device 102 includes one or more processors 202, a non-transitory memory 204 operatively coupled to one or more processors 202, an input/output (I/O) hub 206, a network interface 208, a power source 210, and a communication bus 226.

In this example, one or more processors 202, non-transitory memory 204, I/O hub 206, network interface 208, and power source 210 are illustrated as individual elements of client device 102. However, in one or more embodiments, at least two of one or more processors 202, non-transitory memory 204, I/O hub 206, network interface 208, and power source 210 may be combined as a unitary device. Further, in one or more embodiments, at least one of one or more processors 202, non-transitory memory 204, I/O hub 206, and network interface 208 may be implemented as a computer having non-transitory computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to client device 102 such that the processor may read information from and write information to the tangible computer-readable media. In the alternative, the tangible computer-readable media may be integral to client device 102. The tangible computer-readable media may reside in an integrated circuit (IC), an ASIC, or large-scale integrated circuit (LSI), system LSI, super LSI, or ultra LSI components that perform a part or all of the functions described herein. In the alternative, the tangible computer-readable media may reside as discrete components.

Example tangible computer-readable media may be also coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

In the figure, one or more processors 202, non-transitory memory 204, I/O hub 206, network interface 208, and power source 210 are configured to communicate with one another via communication bus 226.

Non-transitory memory 204 includes a set of instructions of computer-executable program code, an operating system 212, a software application module 214, one or more data stores 216, a short message service (SMS) module 218, an email module 220, and a web browser module 222.

In this example, operating system 212, software application module 214, one or more data stores 216, SMS module 218, email module 220, and web browser module 222 are illustrated as individual elements of non-transitory memory 204. However, in one or more embodiments, at least two of operating system 212, software application module 214, one or more data stores 216, SMS module 218, email module 220, and web browser module 222 may be combined as a unitary element.

The set of instructions within non-transitory memory 204 are executable by one or more processors 202 to cause one or more processors 202 to execute operating system 212 and one or more software applications of software application module 214 that reside in non-transitory memory 204. The one or more software applications residing in non-transitory memory 204 includes, but is not limited to, an enterprise application that is associated with the one or more enterprise servers 104 and which facilitates user access to the one or more user accounts in addition to user management of the one or more user accounts. The enterprise application includes a mobile application that facilitates establishment of a secure connection between client device 102 and one or more enterprise servers 104.

One or more data stores 216 are operable to store one or more types of data. Client device 102 may include one or more interfaces that facilitate one or more systems or modules thereof to transform, manage, retrieve, modify, add, or delete, the data residing in one or more data stores 216. One or more data stores 216 may include volatile and/or non-volatile memory. Examples of suitable data stores 216 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. One or more data stores 216 may be a component of one or more processors 202, or alternatively, may be operatively connected to one or more processors 202 for use thereby. As set forth, described, and/or illustrated herein, “operatively connected” may include direct or indirect connections, including connections without direct physical contact.

SMS module 218 is operable to facilitate user transmission and receipt of text messages via client device 102 though communications network 106. In one example embodiment, a user may receive text messages from the enterprise that are associated with the user access and the user management of the one or more user accounts.

Email module 220 is operable to facilitate user transmission and receipt of email messages via client device 102 through communications network 106. In one example embodiment, a user may receive email messages from the enterprise that are associated with the user access and the user management of the one or more user accounts.

Web browser module 222 is operable to facilitate user access to one or more websites associated with the enterprise through communications network 106.

I/O hub 206 is operable to connect to other systems and subsystems of client device 102. 1/O hub 206 may include one or more of an input interface, an output interface, and a network controller to facilitate communications between client device 102 and one or more enterprise servers 104. The input interface and the output interface may be integrated as a single, unitary user interface 224, or alternatively, be separate as independent interfaces that are operatively connected.

The input interface enable information and/or data to be entered as input commands by a user in a manner that directs one or more processors 202 to execute instructions. The input interface may include a user interface (UI), a graphical user interface (GUI), such as, for example, a display, human-machine interface (HMI), or the like. Embodiments, however, are not limited thereto, and thus, this disclosure contemplates the input interface including a keypad, touch screen, multi-touch screen, button, joystick, mouse, trackball, microphone, and/or combinations thereof.

The output interface may include one or more of a visual display or an audio display, including, but not limited to, a microphone, earphone, and/or speaker. One or more components of client device 102 may serve as both a component of the input interface and a component of the output interface.

Network interface 208 is operable to facilitate connection to communications network 106.

Power source 210 includes at least one of a wired powered source, a wireless power source, a replaceable battery source, a rechargeable battery source, and combinations thereof.

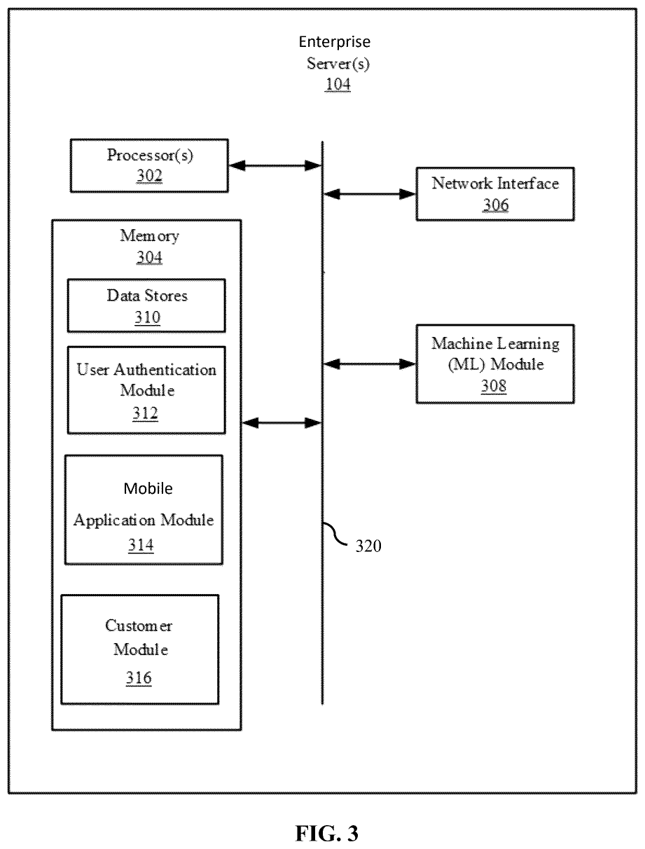

FIG. 3 illustrates a block diagram of one or more enterprise servers 104. It will be understood that it is not necessary for each server in one or more enterprise servers 104 to have all the elements illustrated in FIG. 3. For example, each server in one or more enterprise servers 104 may have any combination of the various elements illustrated in FIG. 3. Moreover, each server in one or more enterprise servers 104 may have additional elements to those illustrated in FIG. 3.

As illustrated in FIG. 3, one or more enterprise servers 104 includes one or more processors 302, a non-transitory memory 304 operatively coupled to one or more processors 302, a network interface 306, a machine learning (ML) module 308, and a communication bus 320.

In this example, one or more processors 302, non-transitory memory 304, network interface 306, and ML module 308 are illustrated as individual elements of one or more enterprise servers 104. However, in one or more embodiments, at least two of one or more processors 302, non-transitory memory 304, network interface 306, and ML module 308 may be combined as a unitary device. Further, in one or more embodiments, at least one of one or more processors 302, non-transitory memory 304, network interface 306, and ML module 308 may be implemented as a computer having non-transitory computer-readable media for carrying or having computer-executable instructions or data structures stored thereon.

In the figure, one or more processors 302, non-transitory memory 304, network interface 306, and ML module 308 are configured to communicate with one another via communication bus 226.

Non-transitory memory 304 includes a set of instructions of computer-executable program code, one or more data stores 310, a user authentication module 312, a mobile application module 314, and a customer module 316.

Network interface 306 is operable to facilitate connection to communications network 106.

In this example, one or more data stores 310, user authentication module 312, mobile application module 314, and customer module 316 are illustrated as individual elements of non-transitory memory 304. However, in one or more embodiments, at least two of one or more data stores 310, user authentication module 312, a mobile application module 314, and customer module 316 may be combined as a unitary element.

The set of instructions in non-transitory memory 304 are executable by one or more processors 302 in manner that facilitates control of a user authentication module 312 and a mobile application module 314 having one or more mobile applications that reside in non-transitory memory 304.

One or more data stores 310 are operable to store one or more types of data, including but not limited to, user account data and user authentication data. One or more data stores 310 may include volatile and/or non-volatile memory. Examples of suitable data stores 310 include, but are not limited to RAM, flash memory, ROM, PROM, EPROM, EEPROM, registers, magnetic disks, optical disks, hard drives, or any other suitable storage medium, or any combination thereof. One or more data stores 310 may be a component of one or more processors 302, or alternatively, may be operatively connected to one or more processors 302 for use thereby. As set forth, described, and/or illustrated herein, “operatively connected” may include direct or indirect connections, including connections without direct physical contact.

The computer-executable program code may instruct one or more processors 302 to cause user authentication module 312 to authenticate a user in order to gain user access to the one or more user accounts. User authentication module 312 may be caused to request user input user data or user identification that include, but are not limited to, user identity (e.g., user name), a user passcode, a cookie, user biometric data, a private key, a token, and/or another suitable authentication data or information.

The computer-executable program code of the one or more mobile applications of mobile application module 314 may instruct one or more processors 302 to execute certain logic, data-processing, and data-storing functions of one or more enterprise servers 104, in addition to certain communication functions of one or more enterprise servers 104. The one or more mobile applications of mobile application module 314 are operable to communicate with client device 102 in a manner which facilitates user access to the one or more user accounts in addition to user management of the one or more user accounts based on successful user authentication.

The computer-executable program code of the one or more customer applications of customer module 316 may instruct one or more processors 302 to execute certain logic, data-processing, and data-storing functions of one or more enterprise servers 104, in addition to certain check classification functions of one or more enterprise servers 104.

In one or more embodiments, as will be described in greater detail below, customer module 316 includes instructions, that when executed by one or more processors 302, cause one or more enterprise servers 104 to: analyze image data associated with an image of a check received by the enterprise; identify a payment amount of the check from the analyzed image data; analyze customer account data when the analyzed image data does not identify at least one of one or more accounts of a customer; classify the check, based on the identified payment amount and the analysis of customer account data, as one classification type within a plurality of different classification types; identify a check processing destination, from a plurality of check processing destinations, based on the one classification type; generate a check processing destination message signal based on the check processing destination; and transmit the check processing destination message signal to a client device to cause display of information related to the check processing destination on a user interface of the client device.

In one or more embodiments, as will be described in greater detail below, customer module 316 includes instructions, that when executed by one or more processors 302, further cause one or more enterprise servers 104 to: identify at least one due date, within the analyzed customer account data, associated with each one or more customer accounts, respectively; and identify a candidate due date of the identified at least one due date, wherein the classifying the check as the one classification type within the plurality of different classification types is additionally based on the identified candidate due date.

In one or more embodiments, as will be described in greater detail below, customer module 316 includes instructions, that when executed by one or more processors 302, further cause one or more enterprise servers 104 to: identify a payment date on the check from the analyzed image data, wherein the classifying the check as the one classification type within the plurality of different classification types is additionally based on the payment date.

In one or more embodiments, as will be described in greater detail below, customer module 316 includes instructions, that when executed by one or more processors 302, further cause one or more enterprise servers 104 to classify the check as the one classification type within the plurality of different classification types when the payment date is prior to the identified candidate due date.

In one or more embodiments, as will be described in greater detail below, customer module 316 includes instructions, that when executed by one or more processors 302, further cause one or more enterprise servers 104 to classify the check as the one classification type within the plurality of different classification types when the payment date is within a predetermined threshold of days dₜₕ of the identified candidate due date.

In one or more embodiments, as will be described in greater detail below, customer module 316 includes instructions, that when executed by one or more processors 302, further cause one or more enterprise servers 104 to: identify at least one payment amount due, within the analyzed customer account data, associated with each one or more customer accounts, respectively; and identify a candidate payment amount due of the identified at least one payment amount due, wherein the classifying the check as the one classification type within the plurality of different classification types is additionally based on the identified candidate payment amount due.

In one or more embodiments, as will be described in greater detail below, customer module 316 includes instructions, that when executed by one or more processors 302, further cause one or more enterprise servers 104 to classify the check as the one classification type within the plurality of different classification types when the payment amount is the same as the identified candidate payment amount due.

In one or more embodiments, as will be described in greater detail below, customer module 316 includes instructions, that when executed by one or more processors 302, further cause one or more enterprise servers 104 to: identify at least one payoff amount due, within the analyzed customer account data, associated with each one or more customer accounts, respectively; and identify a candidate payoff amount due of the identified at least one payoff amount due, wherein the classifying the check as the one classification type within the plurality of different classification types is additionally based on the identified candidate payoff amount due.

In one or more embodiments, as will be described in greater detail below, customer module 316 includes instructions, that when executed by one or more processors 302, further cause one or more enterprise servers 104 to classify the check as the one classification type within the plurality of different classification types when the payment amount is the same as the identified candidate payoff amount due.

In one or more embodiments, as will be described in greater detail below, customer module 316 includes instructions, that when executed by one or more processors 302, further cause one or more enterprise servers 104 to: identify a name from the analyzed image data; identify a name of the customer from the customer account data; and determine whether the name from the analyzed image data corresponds to the name of the customer.

In one or more embodiments, as will be described in greater detail below, customer module 316 includes instructions, that when executed by one or more processors 302, further cause one or more enterprise servers 104 to: generate a return to sender signal when the name from the analyzed image data does not correspond to the name of the customer; and transmit the return to sender signal to a client device to cause display of a return to sender message on a user interface of the client device.

In one or more embodiments, as will be described in greater detail below, customer module 316 includes instructions, that when executed by one or more processors 302, further cause one or more enterprise servers 104 to identify the name from a name data field portion of the analyzed image data.

In one or more embodiments, as will be described in greater detail below, customer module 316 includes instructions, that when executed by one or more processors 302, further cause one or more enterprise servers 104 to: determine whether a second name is in a memo data field portion of the analyzed image data, when the name from the analyzed image data does not correspond to the name of the customer; identify the second name when the second name is in the memo data field portion of the analyzed image data; and determine whether the second name from the analyzed image data corresponds to the name of the customer.

In one or more embodiments, as will be described in greater detail below, customer module 316 includes instructions, that when executed by one or more processors 302, further cause one or more enterprise servers 104 to: generate a return to sender signal when the name from the analyzed image data does not correspond to the name of the customer, when the second name is not in the memo data field portion of the analyzed image data, and when the second name is in the memo data field portion of the analyzed data but does not correspond to the name of the customer; and transmit the return to sender signal to a client device to cause display of a return to sender message on a user interface of the client device.

In one or more embodiments, as will be described in greater detail below, customer module 316 includes instructions, that when executed by one or more processors 302, further cause one or more enterprise servers 104 to: identify at least one due date, within the analyzed customer account data, associated with each one or more customer accounts, respectively; identify a candidate due date of the identified at least one due date; identify at least one payment amount due, within the analyzed customer account data, associated with each one or more customer accounts, respectively; and identify a candidate payment amount due of the identified at least one payment amount due, wherein the classifying the check as the one classification type within the plurality of different classification types is additionally based on the identified candidate due date and the identified candidate payment amount due.

In one or more embodiments, as will be described in greater detail below, customer module 316 includes instructions, that when executed by one or more processors 302, further cause one or more enterprise servers 104 to: identify at least one payoff amount due, within the analyzed customer account data, associated with each one or more customer accounts, respectively; and identify a candidate payoff amount due of the identified at least one payoff amount due, wherein the classifying the check as the one classification type within the plurality of different classification types is additionally based on the identified candidate payoff amount due.

In accordance with one or more embodiments set forth, described, and/or illustrated herein, communications network 106 may include a wireless network, a wired network, or any suitable combination thereof. For example, communications network 106 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

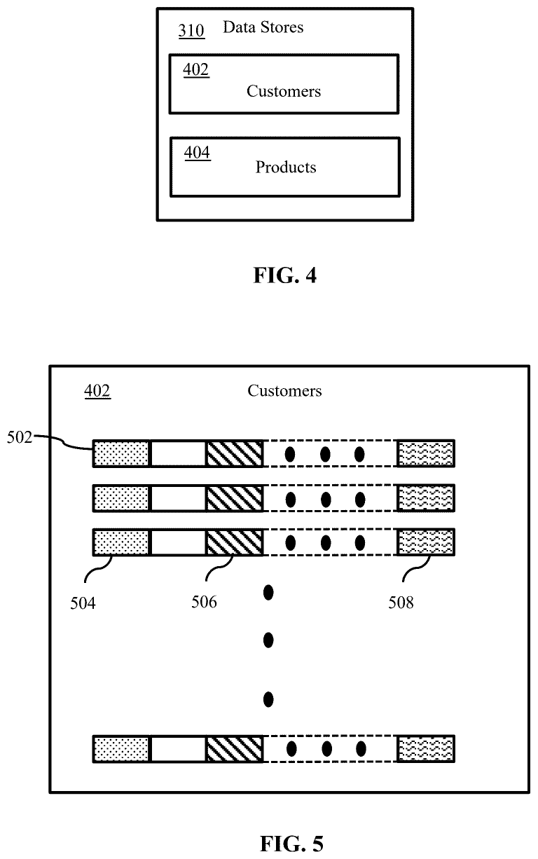

FIG. 4 illustrates a block diagram of data stores 310. As shown in the figure, data stores 310 includes a customers data storage 402 and a products data storage 404.

Customers data storage 402 may be configured to store data associated with each individual customer, non-limiting examples of which include: customer name; customer address; customer phone number(s); customer email address(es); customer start date; customer payment history; and enterprise product(s) of the customer. This will be described in greater detail with reference to FIG. 5.

FIG. 5 illustrates a block diagram of customers data storage 402 of data stores 310. As shown in the figure, customers data storage 402 includes a plurality of customer data structures, a sample of which is indicated as customer data structure 502. Each customer data structure corresponds to a distinct respective customer of the enterprise. Furthermore, each customer data structure includes distinct data portions corresponding to respective distinct data of a respective customer as discussed above.

In one or more embodiments, each customer data structure includes: a customer name data portion, a sample of which is indicated as customer name data portion 504; and plurality customer product data portions, a sample of which are indicated as customer product data portion 506 and customer product data portion 508.

In one or more embodiments, the customer name data portion identifies the name of the customer associated with the customer data structure.

In one or more embodiments, each customer product data portion identifies a respective enterprise product of which the customer currently uses. Non-limiting examples of enterprise products include: deposit accounts including savings accounts, checking accounts, money market accounts, and certificates of deposit (CDs); loans including personal loans, home loans, auto loans, business loans, and home equity loans; credit products including credit cards and lines of credit; investment products including mutual funds, exchange-traded funds (ETFs), stocks, and bonds; foreign exchange services including currency exchange and foreign currency accounts; wealth management products including personal management trusts and investment management accounts; insurance products including life insurance trusts; business services products including cash management solutions, payroll services, and merchant services; digital banking products including online and mobile banking platforms and digital payment solutions; and specialized account products including individual retirement accounts (IRAs) and business accounts.

In one or more embodiments, each customer product data portion of a customer data structure may include a plurality of data portions. This will be described in greater detail with reference to FIG. 6.

FIG. 6 illustrates a block diagram of customer product data portion 506.

As shown in the figure, customer product data portion 506 includes a product identifier data portion 602, a payment amount due data portion 604, a payoff amount due data portion 606, a payment due date data portion 608, and a payment late data portion 610.

In one or more embodiments, product identifier data portion 602 includes data that identifies the enterprise product provided by the enterprise that is associated with the product data structure, and for which the customer is using. For purposes of discussion only, consider an example situation wherein product identifier data portion 602 includes data that identifies the enterprise product to be a home loan.

In one or more embodiments, payment amount due data portion 604 includes data that identifies the payment amount due for the enterprise product provided by the enterprise that is associated with the product data structure, and for which the customer is using. For purposes of discussion only, consider the example situation discussed above, wherein product identifier data portion 602 includes data that identifies the enterprise product to be a home loan. Further, for purposes of discussion only, in this example situation, let payment amount due data portion 604 include data that identifies the payment amount due (for the home loan identified in product identifier data portion 602) to be $2455.32.

In one or more embodiments, payoff amount due data portion 606 includes data that identifies the payoff amount due for the enterprise product provided by the enterprise that is associated with the product data structure, and for which the customer is using. For purposes of discussion only, consider the example situation discussed above, wherein product identifier data portion 602 includes data that identifies the enterprise product to be a home loan. Further, for purposes of discussion only, in this example situation, let payoff amount due data portion 606 include data that identifies the payoff amount due (for the home loan identified in product identifier data portion 602) to be $252,895.26.

In one or more embodiments, payment due date data portion 608 includes data that identifies the payment due data for the product offered by the enterprise for which the customer is using. For purposes of discussion only, consider the example situation discussed above, wherein product identifier data portion 602 includes data that identifies the enterprise product to be a home loan. Further, for purposes of discussion only, in this example situation, let payment due date data portion 608 include data that identifies the payment amount due (for the home loan identified in product identifier data portion 602) to be the first day of every month.

Accordingly, in the example situation discussed above, customer product data portion 506 includes data that identifies a home loan, that has a monthly payment of $2455.32, which is due on the first day of every month.

In one or more embodiments, payment late data portion 610 includes data that indicates whether the payment amount due for the enterprise product provided by the enterprise that is associated with the product data structure, and for which the customer is using, has not been paid by the payment due date identified in payment due date data portion 608. For purposes of discussion only, consider the example situation discussed above, wherein product identifier data portion 602 includes data that identifies the enterprise product to be a home loan, and wherein payment due date data portion indicates that the monthly payment is due on the 1st of every month. Further, for purposes of discussion only, in this example situation, let payment late data portion 610 include data that indicates the monthly payment is 60 days past due.

Returning to FIG. 4, products data storage 404 may be configured to store data associated with enterprise products and promotions provided by the enterprise, non-limiting examples of which include a promotion title or a product title, customer qualification, an introductory rate, an introductory time window, a standard rate, a transfer rate, a credit limit, a change in credit limit, cash-back reward amount, cash-back reward requirement, travel points reward amount, travel points reward requirement, and combinations thereof. Non-limiting examples of enterprise products include: deposit accounts including savings accounts, checking accounts, money market accounts, and certificates of deposit (CDs); loans including personal loans, home loans, auto loans, business loans, and home equity loans; credit products including credit cards and lines of credit; investment products including mutual funds, exchange-traded funds (ETFs), stocks, and bonds; foreign exchange services including currency exchange and foreign currency accounts; wealth management products including personal management trusts and investment management accounts; insurance products including life insurance trusts; business services products including cash management solutions, payroll services, and merchant services; digital banking products including online and mobile banking platforms and digital payment solutions; and specialized account products including individual retirement accounts (IRAs) and business accounts.

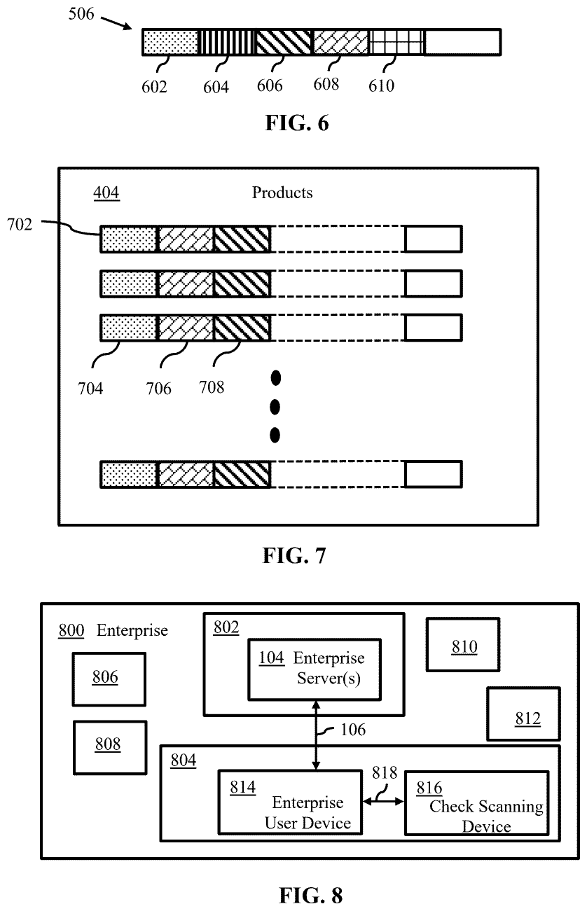

FIG. 7 illustrates a block diagram of products data storage 404 of data stores 310. As shown in the figure, products data storage 404 includes a plurality of product data structures, a sample of which is indicated as product data structure 702. Each product data structure corresponds to a distinct respective product offered by the enterprise. Furthermore, each product data structure includes distinct data portions corresponding to respective distinct data of a respective product.

In one or more embodiments, each product data structure includes: a product name data portion, a sample of which is indicated as product name data portion 704; a product payment processing destination data portion, a sample of which is indicated as product payment processing destination data portion 706; and a product description data portion, a sample of which is indicated as product description data portion 708.

In one or more embodiments, the product name data portion identifies the name of the enterprise product provided by the enterprise that is associated with the product data structure.

In one or more embodiments, the product payment processing destination data portion identifies the destination for which a check payment of the enterprise product, provided by the enterprise that is associated with the product data structure, is to be processed.

In one or more embodiments, the product description data portion includes data describing the enterprise product provided by the enterprise that is associated with the product data structure.

In accordance with aspects of the present disclosure, in one or more embodiments, a computer-implemented method consistently and accurately classifies a received check in order to identify a processing destination of the check.

In accordance with aspects of the present disclosure, in one or more embodiments, once an image of the check is obtained, a computer-implemented method then obtains a name on the check, a payment amount on the check, and a payment data on the check.

In accordance with aspects of the present disclosure, in one or more embodiments, the computer-implemented method then determines whether the name on the check corresponds to a customer of the enterprise.

A non-limiting example of a computer-implemented method for consistently and accurately identifying a check processing destination, of a check that does not identify the enterprise product for which it is to be applied, based on at least one of the payment amount on the check and the payment date on the check in accordance with aspects of the present disclosure will now be described in greater detail with additional reference to FIGS. 8-17.

FIG. 8 illustrates a block diagram of an example enterprise 800 having more than one distinct and geographically separated physical location, wherein at least one physical location is responsible for processing a check that is associated with a first product of a customer of enterprise 800 and at least one other physical location is responsible for processing a check that is associated with a second product of the customer of enterprise 800.

As shown in the figure, enterprise 800 includes a location 802, a location 804, a location 806, a location 808, a location 810, and a location 812. Location 802 includes one or more enterprise servers 104. Further, each of locations 802, 804, 806, 808, 810, and 812 may include one or more enterprise user devices, a sample of which is indicated as enterprise user device 814 located within location 804. Still further, each of locations 802, 804, 806, 808, 810, and 812 may include a check scanning device, a sample of which is indicated as check scanning device 816, located within location 804. One or more enterprise servers 104 are configured to communicate with enterprise user device 814 via communications network 106. Further each check scanning device within a location may communicate with enterprise user devices at that location via a communication channel, an example of which includes check scanning device 816 being configured to communicate with enterprise user device 814 via a communication channel 818.

For purposes of discussion only, let each of locations 802, 804, 806, 808, 810, and 812 be branch offices located in different buildings. Further, for purposes of discussion only: let location 802 not be responsible for processing any checks; let location 804 be responsible for processing checks that are associated with home loans of customers of enterprise 800; let location 806 be responsible for processing checks that are associated with automobile loans of customers of enterprise 800; let location 808 be responsible for processing checks that are associated with home equity lines of credit of customers of enterprise 800; let location 810 be responsible for processing checks that are associated with credit cards of customers of enterprise 800; and let location 812 be responsible for processing checks that are associated with non-collateral loans of customers of enterprise 800.

Enterprise user device 814 may be any device or system that is operable to enable a user to access and interact with one or more enterprise servers 104. Non-limiting examples of enterprise user device 814 include a computer or client device.

Check scanning device 816 may be any device or system that is operable to capture images and extract data from paper checks. In one or more embodiments, check scanning device 816 may utilize contact image sensors or charge couple devices to capture images of both the front and back of a paper check. As will be described in more detail below, in one or more embodiments, check scanning device 816 may utilize optical character recognition (OCR) and magnetic ink character recognition (MICR) to extract critical information such as account numbers, routing numbers, payee details, and amounts.

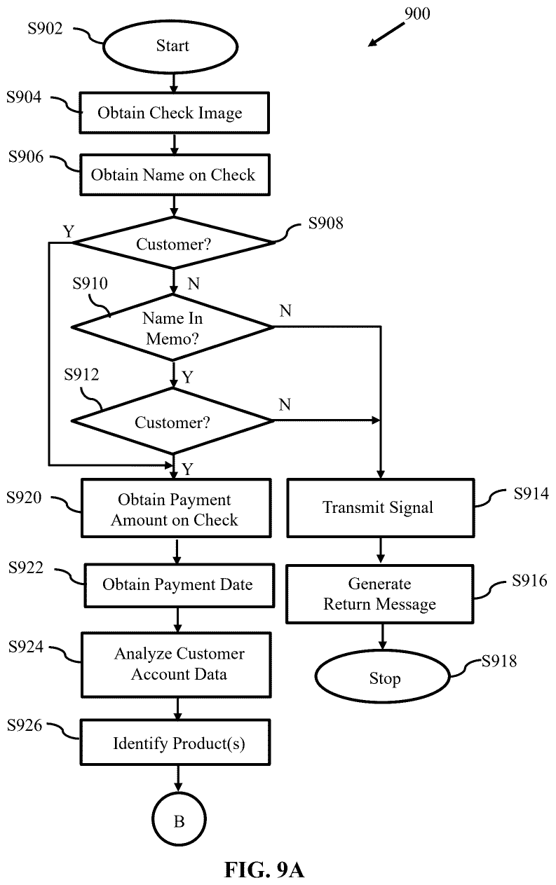

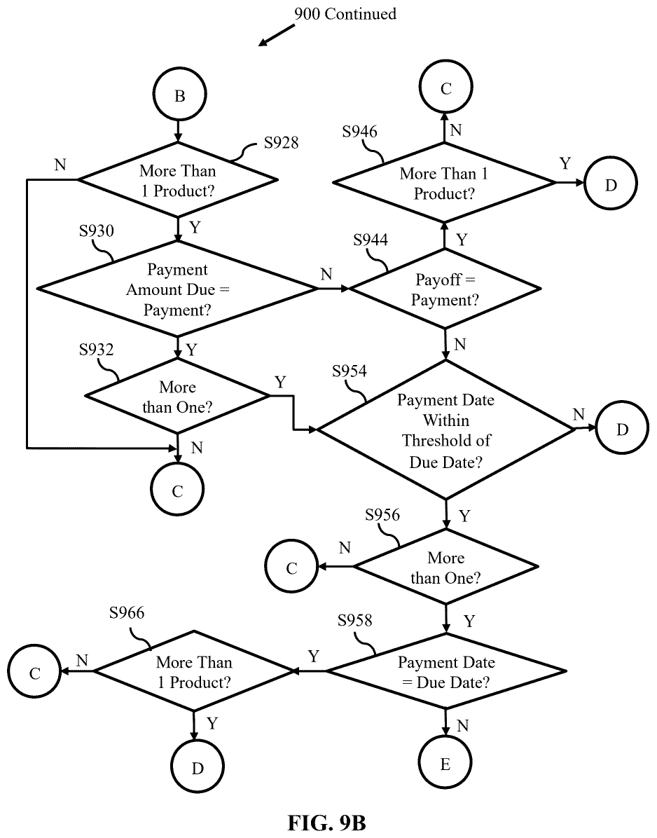

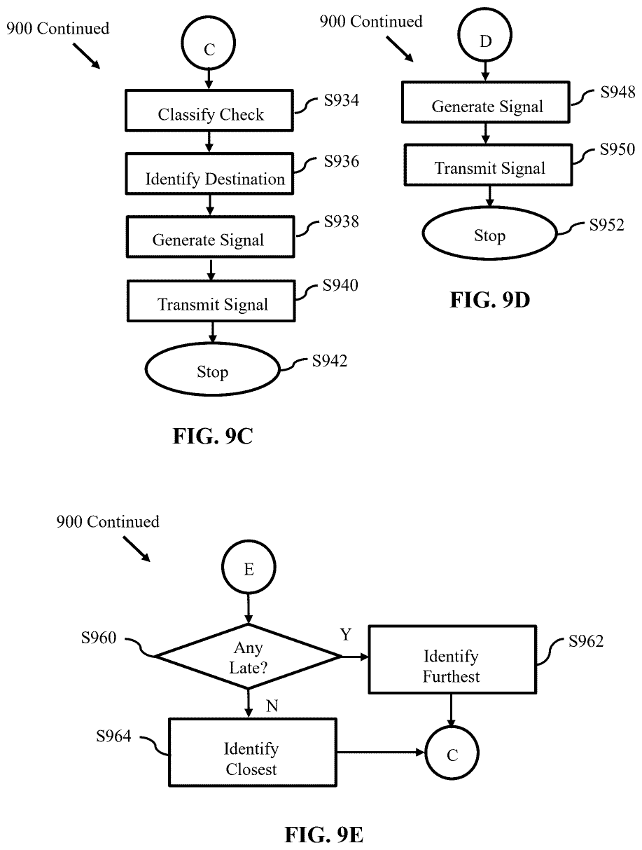

FIG. 9A illustrates a portion of an example computer-implemented method 900 of generating a check message for an employee of an enterprise based on a check that is received by enterprise 800 in accordance with aspects of the present disclosure.

FIG. 9B illustrates a second portion of an example computer-implemented method 900 that continues from a circle B at the bottom of FIG. 9A.

FIG. 9C illustrates a second portion of an example computer-implemented method 900 that continues from circles C of FIG. 9B.

FIG. 9D illustrates a third portion of an example computer-implemented method 900 that continues from a circle D of FIG. 9B.

FIG. 9E illustrates a third portion of an example computer-implemented method 900 that continues from a circle E of FIG. 9B.

Returning to FIG. 9A, computer-implemented method 900 starts (S902) and an image of a check is obtained (S904). For example, returning to FIG. 3, one or more processors 302 may execute instructions in customer module 316 to cause one or more processors 302 to obtain an image of the check.

Returning to FIG. 8, consider a situation in accordance with aspects of the present disclosure, wherein an employee at location 804 of enterprise 800 receives a check. In some cases a check may be received through mail, whereas in some cases a check may be received via personal delivery.

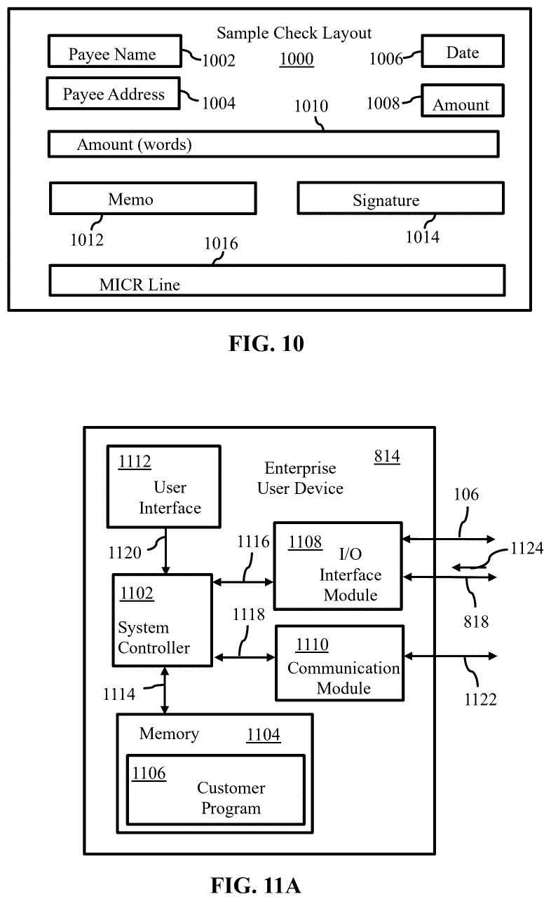

Upon receiving the check, the employee may scan the check via check scanning device 816. In one or more embodiments, check scanning device may output image data associated with the check. In one or more embodiments, the image data may include distinct types of data within respective distinct areas of the check. This will be described in greater detail with reference to FIG. 10.

FIG. 10 illustrates an image 1000 of a sample check layout and the different data fields therein.

As shown in the figure, image 1000 includes a payee name data field 1002, a payee address data field 1004, a date data field 1006, a payment amount data field 1008, a payment amount data field 1010, a memo data field 1012, a signature data field 1014, and a MICR line data field 1016.

Payee name data field 1002 may be configured to contain data corresponding to the name of the owner of the account associated with the check corresponding to image 1000.

Payee address data field 1004 may be configured to contain data corresponding to the mailing address of the owner of the account associated with the check corresponding to image 1000.

Date data field 1006 may be configured to contain data corresponding to the date the check was issued by the owner of the account corresponding to image 1000.

Payment amount data field 1008 may be configured to contain data corresponding to the numerical payment amount associated with the check corresponding to image 1000.

Payment amount data field 1010 may be configured to contain data corresponding to the payment amount, in words, associated with the check corresponding to image 1000.

Memo data field 1012 may be configured to contain data corresponding to optional additional information associated with the check corresponding to image 1000.

Signature data field 1014 may be configured to contain data corresponding to the signature of the owner of the account associated with the check corresponding to image 1000.

MICR line data field 1016 may be configured to contain data corresponding to the routing number of the bank of the owner of the account, the account number, and the check number of the account associated with the check corresponding to image 1000.

Returning to FIG. 8, in one or more embodiments, upon scanning the check, check scanning device 816 obtains the data within each of the payee name data field, the payee address data field, the date data field, the payment amount data field, the payment amount data field, the memo data field, the signature data field, and the MICR line data field.

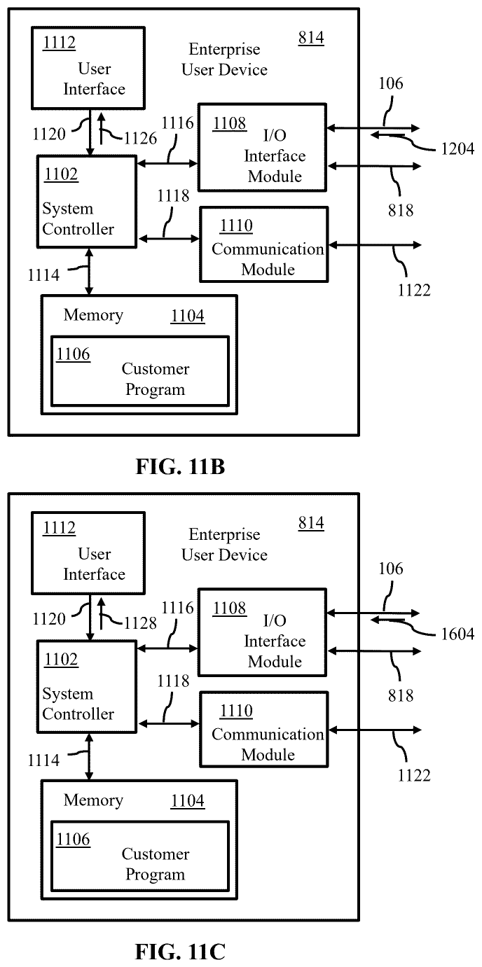

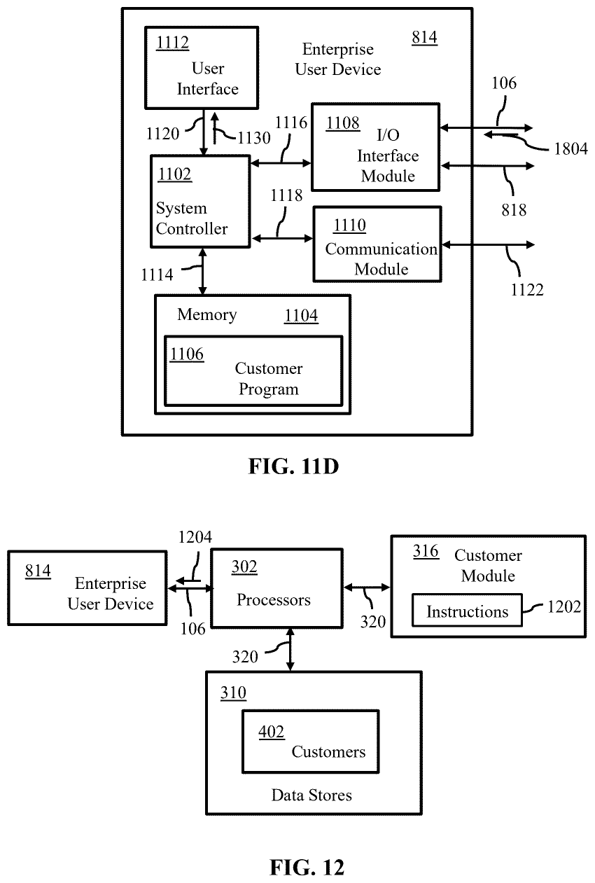

In one or more embodiments, check scanning device 816 transmits the obtained check data from the image of the check to enterprise user device 814. This will be described in greater detail with reference to FIG. 11A.

FIG. 11A illustrates a block diagram of enterprise user device 814 receiving check data. As shown in the figure, enterprise user device 814 includes a system controller 1102, a non-transitory memory 1104 having instructions and a customer program 1106 stored therein, an input/output (I/O) interface module 1108, a communication module 1110, a user interface (UI) 1112, and communication channels 1114, 1116, 1118, 1120, and 1122.

In this example, system controller 1102, non-transitory memory 1104, I/O interface module 1108, communication module 1110, and UI 1112 are illustrated as individual elements of one or more enterprise user device 814. However, in one or more embodiments, at least two of system controller 1102, non-transitory memory 1104, I/O interface module 1108, communication module 1110, and UI 1112 may be combined as a unitary device. Further, in one or more embodiments, at least one of system controller 1102, non-transitory memory 1104, I/O interface module 1108, communication module 1110, and UI 1112 may be implemented as a computer having non-transitory computer-readable media for carrying or having computer-executable instructions or data structures stored thereon.

System controller 1102 is operable to communicate with: non-transitory memory 1104 via communication channel 1114; I/O interface module 1108 via communication channel 1116; communication module 1110 via communication channel 1118; and UI 1112 via communication channel 1120.

I/O interface module is additionally configured to communicate with one or more enterprise servers 104 via communications network 106, and to communicate with check scanning device 816 via communication channel 818.

Communication module 1110 is additionally configured to communicate with client device 102 via communication channel 1122 and communications network 106.

Each of communication channels 1114, 1116, 1118, 1120, and 1122 may be any known type of communication channel, including wired and wireless.

System controller 1102 may be any device or system that is operable to control general operations of enterprise user device 814 and includes, but is not limited to, a CPU, a hardware microprocessor, a single core processor, a multi-core processor, an FPGA, a microcontroller, an ASIC, a DSP, or other similar processing device capable of executing any type of instructions, algorithms, or software for controlling the operation and functions of enterprise user device 814.

Non-transitory memory 1104 may be any device or system capable of storing data and instructions used by enterprise user device 814 and includes, but is not limited to, RAM, DRAM, a hard drive, a solid-state drive, ROM, EPROM, EEPROM, flash memory, embedded memory blocks in an FPGA, or any other various layers of memory hierarchy.

I/O interface module 1108 is operable to connect to one or more enterprise servers 104. I/O interface module 1108 may include one or more of an input interface, an output interface, and a network controller to facilitate communications between enterprise user device 814 and one or more enterprise servers 104. The input interface and the output interface may be integrated as a single, unitary interface, or alternatively, be separate as independent interfaces that are operatively connected.

Communication module 1110 may be any device or system that is operable to facilitate user communications with devices external to enterprise 800. In one or more embodiments, communication module 1110 is operable to enable transmission of text messages from enterprise user device 814 to client device 102 though communications network 106 via communication channel 1122. In one or more embodiments, communication module 1110 is operable to enable receipt of text messages from client device 102 by enterprise user device 814 though communications network 106 via communication channel 1122. In one or more embodiments, communication module 1110 is operable to enable transmission of email messages from enterprise user device 814 to client device 102 though communications network 106 via communication channel 1122. In one or more embodiments, communication module 1110 is operable to enable receipt of email messages from client device 102 by enterprise user device 814 though communications network 106 via communication channel 1122. In one or more embodiments, communication module 1110 is operable to facilitate user access to one or more websites through communications network 106.

UI 1112 may be any device, software, component, system, element, or arrangement or groups thereof that enable information and/or data to be entered as input commands by a user in a manner that directs system controller 1102 to execute instructions and that enable information/data to be presented to a user. UI 1112 may include a user interface (UI), a graphical user interface (GUI), such as, for example, a display, human-machine interface (HMI), or the like. Embodiments, however, are not limited thereto, and thus, this disclosure contemplates UI 1112 including a keypad, touch screen, multi-touch screen, button, joystick, mouse, trackball, microphone and/or combinations thereof. UI 1112 may additionally include one or more of a visual display or an audio display, including, but not limited to, a microphone, earphone, and/or speaker.

Customer program 1106 includes instructions that when executed by system controller 1102, enable enterprise user device 814 to perform the functions disclosed herein.

In one or more embodiments, as will be described in greater detail below, customer program 1106 includes instructions, that when executed by system controller 1102, cause system controller 1102 to cause I/O interface module 1108 to send check data received from check scanning device 816 to one or more enterprise servers 104.

In one or more embodiments, as will be described in greater detail below, customer program 1106 includes instructions, that when executed by system controller 1102, cause system controller 1102 to cause UI 1112 to display a message related to the check processing destination.

In one or more embodiments, as will be described in greater detail below, customer program 1106 includes instructions, that when executed by system controller 1102, cause system controller 1102 to cause UI 1112 to display a message to return the check to the sender of the check.

In operation, I/O interface module 1108 receives check data 1124 from check scanning device 816, and provides check data 1124 to system controller 1102.

In one or more embodiments, check data 1124 may take the form of image data of an image of the check.

In one or more embodiments, check data 1124 may take the form of an encoded packet that includes: a data portion having data associated with payee name data field 1002; a data portion having data associated with payee address data field 1004; a data portion having data associated with date data field 1006; a data portion having data associated with payment amount data field 1008; a data portion having data associated with payment amount data field 1010; a data portion having data associated with memo data field 1012; a data portion having data associated with signature data field 1014; and a data portion having data associated with MICR line data field 1016.

Returning to FIG. 9A, after an image of the check is obtained (S904), a name on the check is obtained (S906). For example, returning to FIG. 11A, system controller 1102 may execute instructions in customer program 1106 to cause I/O interface module 1108 to transmit the check data, which was received from check scanning device 816, to one or more enterprise servers 104. Returning to FIG. 3, one or more processors 302 may execute instructions in customer module 316 to cause one or more processors 302 to obtain a name from the check data.

Returning to FIG. 10, in one or more embodiments, one or more processors 302 may execute instructions in customer module 316 to cause one or more processors 302 to obtain a name from the check data from the data within payee name data field 1002 of the check data.

In one or more embodiments, one or more processors 302 may execute instructions in customer module 316 to cause one or more processors 302 to obtain a name from the check data from the data within signature data field 1014 of the check data.

In one or more embodiments, one or more processors 302 may execute instructions in customer module 316 to cause one or more processors 302 to obtain a name from the check data from the data within memo data field 1012 of the check data.

Returning to FIG. 9A, after the name on the check is obtained (S906), it is determined whether the obtained name corresponds to a customer of enterprise 800 (S908). For example, returning to FIG. 3, one or more processors 302 may execute instructions in customer module 316 to cause one or more processors 302 to determine whether the obtained name corresponds to a customer of enterprise 800. This will be described in greater detail with reference to FIG. 12.

FIG. 12 illustrates a block diagram of one or more processors 302, customers data storage 402 of one or more data stores 310, customer module 316, and enterprise user device 814 for determining whether the obtained name corresponds to a customer of enterprise 800 in accordance with aspects of the present disclosure. Customer module 316 includes instructions 1202 stored therein.

In one or more embodiments, one or more processors 302 execute instructions 1202 to cause one or more processors 302 to determine whether the name on the check corresponds to any of the names of the customers. In one or more embodiments, one or more processors 302 execute instructions 1202 to compare a name provided by the payee name data field or the signature data field of the check data with the customer name data portion within each customer data structure, within customers data storage 402, within one or more data stores 310.

In one or more embodiments, if processors 302 determine that the name on the check does not match any of the names of any the customers, one or more processors 302 determine that the name on the check does not correspond to a customer of enterprise 800.

In one or more embodiments, if processors 302 determine that the name on the check matches a name of a customer, one or more processors 302 determines that the name on the check does correspond to an identified customer of enterprise 800. For example, in many cases, a customer will send a check to an enterprise to pay for a product of that customer, wherein the check includes the name of the customer. For example, a customer John Black, who has a car loan from enterprise 800, may send enterprise 800 a check for payment on his car loan, wherein “John Black” is in either the payee name data field or the signature data field of the check.

Returning to FIG. 9A, if it is determined that the obtained name does not correspond to a customer of enterprise 800 (N at S908), it is determined whether a name is in the memo portion of the check (S910). For example, returning to FIG. 3, one or more processors 302 may execute instructions in customer module 316 to cause one or more processors 302 to determine whether a name is in the memo portion of the check.

Returning to FIG. 12, in one or more embodiments, one or more processors 302 execute instructions 1202 to cause one or more processors 302 to determine whether a name is in the memo data field on the check.

In one or more embodiments, one or more processors 302 execute instructions 1202 to cause one or more processors 302 to identify whether data in the memo data field corresponds to a name by any known method, a non-limiting example of which includes optical character recognition combined with a large language model that has been trained to identify industry standard language.

In one or more embodiments, one or more processors 302 execute instructions 1202 to cause one or more processors 302 to identify whether data in the memo data field corresponds to operational definitions of enterprise 800, non-limiting examples of which include account number and product type.

Returning to FIG. 9A, if it is determined that a name is in the memo portion of the check (Y at S910), it is determined whether the name in the memo portion of the check corresponds to a customer of enterprise 800 (S912). For example, returning to FIG. 3, one or more processors 302 may execute instructions in customer module 316 to cause one or more processors 302 to determine whether the name in the memo portion of the check corresponds to a customer of enterprise 800.

If one or more processors 302 determine that a name is in the memo data field on the check, one or more processors 302 execute instructions 1202 to cause one or more processors 302 to determine whether the name in the memo data field on the check corresponds to any of the names of the customers. In one or more embodiments, one or more processors 302 execute instructions 1202 to compare a name provided by memo field with the customer name data portion within each customer data structure, within customers data storage 402, within one or more data stores 310.

In one or more embodiments, if processors 302 determine that there is no name in the memo data field of the check, one or more processors 302 determine that the name on the check does not correspond to a customer of enterprise 800. In one or more embodiments, if processors 302 determine that there is a name in the memo data field of the check, but the name on memo data field of the check does not match any of the names of any the customers, one or more processors 302 determine that the name on the check does not correspond to a customer of enterprise 800.

In one or more embodiments, if processors 302 determine that a name in the memo data field on the check matches a name of a customer, one or more processors 302 determines that the name in the memo data field on the check does correspond to an identified customer of enterprise 800. For example, in some cases, a person who is not a customer of an enterprise will send a check to enterprise 800 to pay for a product for another person, who is a customer of enterprise 800. In some of these cases, the person writing the check may put the name of the customer in the memo data field of the check. For example, let Mary Black be the mother of a customer John Black, who has a car loan from enterprise 800. Further, in this example, let Mary Black not be a customer of enterprise 800. In some situations, Mary Black may want to pay the car loan for her son, John Black. In some of these situations, Mary may send enterprise 800 a check for payment on John Black's car loan, wherein “Mary Black” is in either the payee name data field or the signature data field of the check, but “John Black” is not in either the payee name data field or the signature data field of the check. However, in some of these situations, Mary Black may put “John Black” in the memo data field of the check to inform enterprise 800 that the check is to be applied to a product used by John Black.

Returning to FIG. 9A, if it is determined that the name in the memo portion of the check corresponds to a customer of enterprise 800 (N at S912), or if it is determined that there is no name is the memo portion of the check (N at S910), a return to sender signal is transmitted (S914). For example, returning to FIG. 3, one or more processors 302 may execute instructions in customer module 316 to cause one or more processors 302 to transmit a return to sender signal. As shown in FIG. 12, one or more processors 302 may execute instructions 1202 to cause one or more one or more processors 302 to generate a return to sender signal 1204.

Returning to FIG. 9A, after a return to sender signal is transmitted (S914), a return to sender message is generated (S916). For example, returning to FIG. 8, one or more enterprise servers 104 may transmit a return to sender signal to enterprise user device 814 to cause enterprise user device 814 to generate a return to sender message. This will be described in greater detail with reference to FIGS. 11B-12.

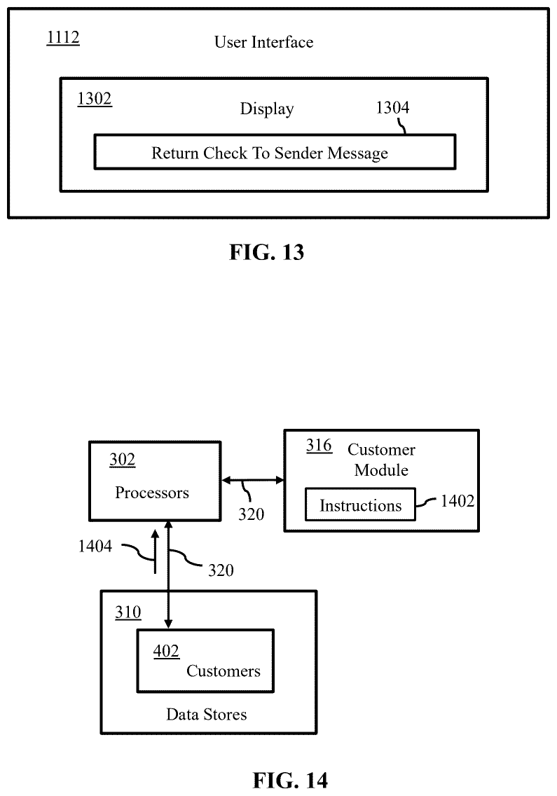

As shown in FIG. 11B, upon receiving return to sender signal 1204, system controller 1102 may execute instructions within customer program 1106 to cause system controller 1102 to transmit a display signal 1126 to UI 1112. Display signal 1126 causes UI 1112 to display a return to sender message. This will be described in greater detail with reference to FIG. 13.

FIG. 13 illustrates UI 1112 of enterprise user device 814 displaying a return to sender message in accordance with aspects of the present disclosure. As shown in the figure, UI 1112 includes a display 1302 displaying a return to sender message 1304.

For purposes of explanation, consider the situation wherein an employee at location 804 receives a check, scans the check, and sends the check data to one or more enterprise servers 104. Further, let the check not correspond to a customer of enterprise 800. In one or more embodiments, customer module 316 may have instructions stored therein, that when executed by one or more processors 302, cause one or more enterprise servers 104 to instruct UI 1112 of enterprise user device 814 to display a message for the representative, “Return Check to Sender.”

In accordance with aspects of the present disclosure, in one or more embodiments, after a name on the check is obtained (S904), the computer-implemented method then generates a return to sender signal when the name on the check does not correspond to a customer of the enterprise (N at S908 and N at S910), wherein the return to sender signal causes a user device of an employee of the enterprise to display a message to return the check to the sender of the check (S916).

With respect to the return to sender signal discussed above, for purposes of discussion only, consider an example enterprise, called Company, offers home loans, automobile loans, and credit cards to its customers. Further, in this example enterprise, let check payments for home loans be processed at a Greenfield Branch at a Greenfield location, let received check payments for automobile loans be processed at Redfield Branch at a Redfield location that is geographically separated from the Greenfield Branch, and let credit card payments be processed at a Whitefield Branch at a Whitefield location that is geographically separated from the Greenfield Branch and the Redfield Branch. Still further, in this example enterprise, let all checks be initially received by Company at a Blackfield Branch at a Blackfield location that is geographically separated from the Greenfield Branch, the Redfield Branch, and the Whitefield Branch.

Now, consider an example situation, wherein John Doe inadvertently sends a check to Company, and wherein John Doe is not a customer of Company. In this example situation, a Company employee at the Blackfield location would receive the check and scan the check. The computer-implemented method would ultimately cause a display on an enterprise user device of the employee of the Company to display a message, “Return Check to John Doe.” In this manner, the employee would not need to waste time by contacting each of the Greenfield, Whitefield, and Redfield Branches to determine whether they should process the check.

After a return to sender message is generated (S916), computer-implemented method 900 stops (S918)

Returning to FIG. 9A, if it is determined that the obtained name on the check corresponds to a customer of enterprise 800 (Y at S908) or if the name in the memo of the check corresponds to a customer of enterprise 800 (Y at S912), the payment amount on the check is obtained (S920). For example, returning to FIG. 3, one or more processors 302 may execute instructions in customer module 316 to cause one or more processors 302 to obtain the payment amount on the check.

Returning to FIG. 10, in one or more embodiments, one or more processors 302 may execute instructions in customer module 316 to cause one or more processors 302 to obtain a payment amount from the check data from the data within payment amount data field 1008 of the check data.

In one or more embodiments, one or more processors 302 may execute instructions in customer module 316 to cause one or more processors 302 to obtain a payment amount from the check data from the data within payment amount data field 1010 of the check data.

Returning to FIG. 9A, after the payment amount on the check is obtained (S920), the payment date on the check is obtained (S922). For example, returning to FIG. 3, one or more processors 302 may execute instructions in customer module 316 to cause one or more processors 302 to obtain the payment date on the check.

Returning to FIG. 10, in one or more embodiments, one or more processors 302 may execute instructions in customer module 316 to cause one or more processors 302 to obtain a payment date from the check data from the data within date data field 1006 of the check data.

Returning to FIG. 9A, after the payment date on the check is obtained (S922), customer account data is analyzed (S924). For example, returning to FIG. 3, one or more processors 302 may execute instructions in customer module 316 to cause one or more processors 302 to analyze customer account data. This will be described in greater detail with reference to FIG. 14.

FIG. 14 illustrates a block diagram of one or more processors 302, customers data storage 402, and customer module 316 for analyzing customer account data in accordance with aspects of the present disclosure. Customer module 316 include instructions 1402 stored therein.

In one or more embodiments, one or more processors 302 execute instructions 1402 to cause one or more processors 302 to retrieve from customers data storage 402, the customer data structure 1404 corresponding to the customer associated with the name on the check (or the name in the memo data field if applicable). In one or more embodiments, one or more processors 302 execute instructions 1402 to cause one or more processors 302 to analyze each customer product data portion within retrieved customer data structure 1404.

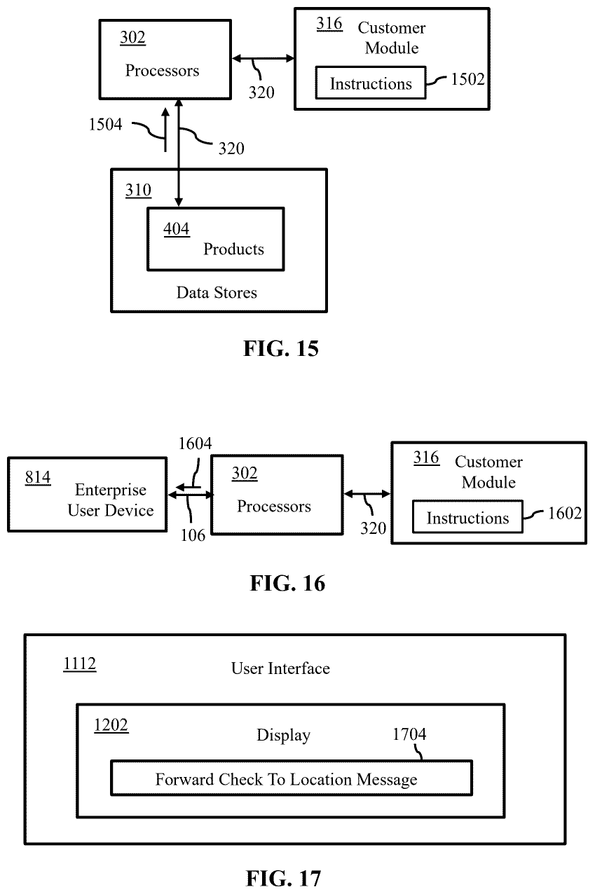

Returning to FIG. 9A, after customer account data is analyzed (S924), products are identified (S926). For example, returning to FIG. 3, one or more processors 302 may execute instructions in customer module 316 to cause one or more processors 302 to identify products. This will be described in greater detail with reference to FIG. 15.

FIG. 15 illustrates a block diagram of one or more processors 302, products data storage 404 within data stores 310, and customer module 316 for identifying products in accordance with aspects of the present disclosure. Customer module 316 include instructions 1502 stored therein.

In one or more embodiments, one or more processors 302 execute instructions 1502 to cause one or more processors 302 to retrieve from products data storage 404, all products data structures 1504 that correspond to enterprise products that are associated with each customer product data portion within previously retrieved customer data structure 1404.

Returning to FIG. 9A, after products are identified (S926), it is determined whether the customer has more than one product of enterprise 800 (S928 as shown in FIG. 9B). For example, returning to FIG. 3, one or more processors 302 may execute instructions in customer module 316 to cause one or more processors 302 to determine whether the customer has more than one product of enterprise 800.

Returning to FIG. 14, in one or more embodiments, one or more processors 302 execute instructions 1402 to cause one or more processors 302 to determine whether there is more than one customer product data portion within previously retrieved customer data structure 1404. In the case where there is more than each customer product data portion within previously retrieved customer data structure 1404, one or more processors 302 would determine that the customer associated with the customer data structure 1404 has more than one product of enterprise 800. In the case where there is only one product data portion within previously retrieved customer data structure 1404, one or more processors 302 would determine that the customer associated with the customer data structure 1404 has only one product of enterprise 800.

Returning to FIG. 9B, if it is determined that the customer has more than one product of enterprise 800 (Y at S928), it is determined whether the payment amount due is equal to the payment amount on the check (S930). For example, returning to FIG. 3, one or more processors 302 may execute instructions in customer module 316 to cause one or more processors 302 to determine whether the payment amount due is equal to the payment amount on the check.

Returning to FIG. 14, in one or more embodiments, one or more processors 302 execute instructions 1402 to cause one or more processors 302 to identify each payment amount due for each customer product data portion within previously retrieved customer data structure 1404. In one or more embodiments, one or more processors 302 execute instructions 1202 to compare the payment amount on the check provided by the payment amount data field of the check data with the payment amount due for each customer product data portion within previously retrieved customer data structure 1404.

In the case where the payment amount on the check is the same as the payment amount due for at least one customer product data portion within previously retrieved customer data structure 1404, one or more processors 302 would determine that the payment amount due is equal to the payment amount on the check. In the case where the payment amount on the check is not the same as the payment amount due for any customer product data portion within previously retrieved customer data structure 1404, one or more processors 302 would determine that the payment amount due is not equal to the payment amount on the check.

Returning to FIG. 9B, if it is determined that the payment amount due is equal to the payment amount on the check (Y at S930), it is determined whether the payment amount on the check is equal to the payment amount due on more than one product of enterprise 800 (S932). For example, returning to FIG. 3, one or more processors 302 may execute instructions in customer module 316 to cause one or more processors 302 to determine whether the payment amount on the check is equal to the payment amount due on more than one product of enterprise 800.

Returning to FIG. 14, in one or more embodiments, one or more processors 302 execute instructions 1402 to cause one or more processors 302 to determine whether the payment amount on the check is the same as the payment amount due for more than one customer product data portion within previously retrieved customer data structure 1404. In one or more embodiments, one or more processors 302 execute instructions 1202 to identify all customer product data portions within previously retrieved customer data structure 1404 that have a payment amount due that is the same as the payment amount on the check provided by the payment amount data field of the check data.

In the case where the payment amount on the check is the same as the payment amount due for more than one customer product data portion within previously retrieved customer data structure 1404, one or more processors 302 would determine that the payment amount on the check is equal to the payment amount due on more than one product of enterprise 800. In the case where the payment amount on the check is the same as the payment amount due for only one customer product data portion within previously retrieved customer data structure 1404, one or more processors 302 would determine that the payment amount on the check is equal to the payment amount due on only one product of enterprise 800.

Returning to FIG. 9B, if it is determined that the payment amount on the check is not equal to the payment amount due on more than one product of enterprise 800 (N at S932), or if it is determined that the customer does not have more than one product of enterprise 800 (N at S928), then the check is classified (S934 as shown in FIG. 9C). For example, returning to FIG. 3, one or more processors 302 may execute instructions in customer module 316 to cause one or more processors 302 to classify the check.

Returning to FIG. 14, in one or more embodiments, one or more processors 302 execute instructions 1402 to cause one or more processors 302 to: 1) identify the only product of the enterprise 800 for which the payment amount due is equal to the payment amount on the check, in the case where the payment amount on the check is equal to only one payment amount due, via product identification data within the customer product data portion within the customer data structure; or 2) identify the only product of the enterprise for the customer, in the case it is determined that the customer has only one product of enterprise, via product identification data within the customer product data portion within the customer data structure.

Once the product is identified, in one or more embodiments, one or more processors 302 execute instructions 1402 to cause one or more processors 302 to classify the check based on the product of enterprise 800.

Returning to FIG. 9C, after the check is classified (S934), a check processing destination is identified (S936). For example, returning to FIG. 3, one or more processors 302 may execute instructions in customer module 316 to cause one or more processors 302 to identify a check processing destination for the check.

Returning to FIG. 15, in one or more embodiments, one or more processors 302 execute instructions 1502 to cause one or more processors 302 to identify the product of enterprise 800 for which the check is classified. Once identified, in one or more embodiments, one or more processors 302 execute instructions 1402 to cause one or more processors 302 to obtain the check processing destination, for which payment of the enterprise product should be processed, from the product payment destination data portion of the product data structure.

For purposes of discussion only, consider an example, wherein enterprise 800 offers home loans, automobile loans, credit cards, home equity lines of credit, and business loans to its customers. Further, in this example, returning to FIG. 8, let check payments for home loans be processed at location 804, let check payments for automobile loans be processed at location 806, let check payments for credit card be processed at location 808, let check payments for home equity lines of credit be processed at location 810, and let check payments for business loans be processed at location 812. Still further, in this example enterprise, let all checks be initially received by enterprise 800 at location 804.

Now, consider an example situation, wherein Jessica Doe only has a car loan from enterprise 800, wherein Jessica sends a check to enterprise 800, and wherein the check does not identify the car loan. In this example situation, returning to FIG. 6, the product identifier data portion 602 would identify the product of enterprise 800 that is associated with Jessica as a car loan. In this example situation, returning to FIG. 7, product payment processing destination data portion 706 would identify the check processing destination of enterprise 800 for processing check payments of automobile loans, which in this example situation would be location 806.

Returning to FIG. 9C, after a check processing destination for the check is identified (S936), a check processing destination message signal is generated (S938). For example, returning to FIG. 3, one or more processors 302 may execute instructions in customer module 316 to cause one or more processors 302 to generate a check processing destination message signal.

Returning to FIG. 9C, after a check processing destination message signal is generated (S938), the check processing destination message signal is transmitted (S940). For example, returning to FIG. 3, one or more processors 302 may execute instructions in customer module 316 to cause one or more processors 302 to transmit the check processing destination message signal. This will be described in greater detail with reference to FIG. 16.

FIG. 16 illustrates a block diagram of one or more processors 302, customer module 316, and enterprise user device 814 for transmitting a check processing destination message signal in accordance with aspects of the present disclosure. Customer module 316 includes instructions 1602 stored therein.

As shown in FIG. 16, one or more processors 302 may execute instructions 1602 to cause one or more one or more processors 302 to transmit a check processing destination message signal 1604, based on the identified check processing destination, to enterprise user device 814. This will be described in greater detail with reference to FIG. 11C.

FIG. 11C illustrates a block diagram of enterprise user device 814 receiving check processing destination message signal 1604.

As shown in the figure, upon receiving check processing destination message signal 1604, system controller 1102 may execute instructions within customer program 1106 to cause system controller 1102 to transmit a display signal 1128 to UI 1112. Display signal 1128 causes UI 1112 to display a check processing destination message. This will be described in greater detail with reference to FIG. 17.

FIG. 17 illustrates UI 1112 of enterprise user device 814 displaying a check processing destination message in accordance with aspects of the present disclosure. As shown in the figure, display 1302 is displaying a check processing destination message 1704.

For purposes of explanation, consider the situation wherein an employee at location 804 receives a check, scans the check, and sends the check data to one or more enterprise servers 104. Further, let the check correspond to a customer of enterprise 800, let the check be for payment on a car loan, and let location 806 be the location for which check payments for automobile loans are processed. In one or more embodiments, customer module 316 may have instructions stored therein, that when executed by one or more processors 302, cause one or more enterprise servers 104 to instruct UI 1112 of enterprise user device 814 to display a message for the representative, “Send the check to location 806.”

In accordance with aspects of the present disclosure, in one or more embodiments, when the name on the check does correspond to a customer of the enterprise (Y at S908), the computer-implemented method determines whether the customer, who corresponds to the name on the check, has more than one product of the enterprise for which the payment amount on the check should be applied. In one or more of these embodiments, if the customer has only one product of the enterprise for which the payment amount on the check should be applied (N at S928), the computer-implemented method then identifies a check processing destination, from a plurality check processing destinations of the enterprise, which corresponds to the one product of the customer. In one or more of these embodiments, the computer-implemented method then generates check processing destination message signal that causes a user device of an employee of the enterprise to display a message to forward the check to the identified check processing destination (S938).

With respect to the check processing destination discussed above, for purposes of discussion only, consider the example enterprise, called Company, discussed above. Further, consider an example situation wherein Jane Doe sends a check to Company, and wherein Jane Doe only has a home loan from Company. However, in this example situation, let the check not have any information that identifies which Company product for which the payment amount of the check is to be applied. In this example situation, a Company employee at the Blackfield location would receive the check and scan the check. The computer-implemented method would: 1) determine that Jane Doe only has a home loan with Company, and therefore determine that the payment amount of the check should be applied to the home loan; 2) determine that home loan checks are to be processed at the Greenfield Branch; and 3) cause a display on an enterprise user device of the employee of the Company to display a message, “Forward Jane Doe's check to Greenfield Branch.” In this manner, the employee would not need to waste time by contacting each of the Whitefield and Redfield Branches to determine whether they should process Jane Doe's check.

In accordance with aspects of the present disclosure, in one or more embodiments, when the name on the check does correspond to a customer of the enterprise (Y at S908), when the customer, who corresponds to the name on the check, has more than one product of the enterprise for which the payment amount on the check should be applied (Y at S928), the computer-implemented method then determines whether the payment amount due for any of the products of the customer is equal to the payment amount on the check. In one or more of these embodiments, if the payment amount due for any of the products of the customer is equal to the payment amount on the check (Y at S930), the computer-implemented method determines whether the payment amount due on more than one product is equal to the payment amount on the check (S932). In one or more of these embodiments, if the payment amount due on only one product is equal to the payment amount on the check (N at S932), the computer-implemented method then identifies a check processing destination, from a plurality check processing destinations of the enterprise, that corresponds to the one product that has a payment amount due that is equal to the payment amount on the check. In one or more of these embodiments, the computer-implemented method then generates a check processing destination message signal that causes a user device of an employee of the enterprise to display a message to forward the check to the check processing destination (S940).

With respect to the check processing destination discussed above, for purposes of discussion only, consider the example enterprise, called Company, discussed above. Further, consider an example situation, wherein Jimmy Doe sends a check to Company, wherein Jimmy Doe has a home loan from Company with a monthly payment amount due of $2412.63, and wherein Jimmy Doe also has a car loan from Company with a monthly payment amount due of $566.23. However, in this example situation, let the check have a payment amount of $566.23, but not have any information that identifies which Company product for which the payment amount of the check is to be applied. In this example situation, a Company employee at the Blackfield location would receive the check and scan the check. The computer-implemented method would: 1) determine that Jimmy Doe only has a car loan with Company that has a payment amount due that is equal to the payment amount on the check, and therefore determine that the payment amount of the check should be applied to the car loan; 2) determine that car loan checks are to be processed at the Redfield Branch; and 3) cause a display on an enterprise user device of the employee of the Company to display a message, “Forward Jimmy Doe's check to Redfield Branch.” In this manner, the employee would not need to waste time by contacting each of the Whitefield and Greenfield Branches to determine whether they should process Jimmy Doe's check.

Returning to FIG. 9C, after the check processing destination message signal is transmitted (S940), computer-implemented method 900 stops.

Returning to FIG. 9B, if it is determined that the payment amount due is not equal to the payment amount on the check (N at S930), then it is determined whether the payoff amount due on a product is equal to the payment amount on the check (S944). For example, returning to FIG. 3, one or more processors 302 may execute instructions in customer module 316 to cause one or more processors 302 to determine whether the payoff amount due on a product is equal to the payment amount on the check.

Returning to FIG. 14, in one or more embodiments, one or more processors 302 execute instructions 1402 to cause one or more processors 302 to identify each payoff amount due for each customer product data portion within previously retrieved customer data structure 1404. In one or more embodiments, one or more processors 302 execute instructions 1202 to compare the payment amount on the check provided by the payment amount data field of the check data with the payoff amount for each customer product data portion within previously retrieved customer data structure 1404.

In the case where the payment amount on the check is the same as the payoff amount due for at least one customer product data portion within previously retrieved customer data structure 1404, one or more processors 302 would determine that the payoff amount due is equal to the payment amount on the check. In the case where the payment amount on the check is not the same as the payoff amount due for any customer product data portion within previously retrieved customer data structure 1404, one or more processors 302 would determine that the payoff amount due is not equal to the payment amount on the check.

Returning to FIG. 9B, if it is determined that the payoff amount due on a product is equal to the payment amount on the check (S944), it is determined whether the payment amount due on more than one product is equal to the payment amount on the check (S946). For example, returning to FIG. 3, one or more processors 302 may execute instructions in customer module 316 to cause one or more processors 302 to determine whether the payoff amount due on more than one product is equal to the payment amount on the check.

Returning to FIG. 14, in one or more embodiments, one or more processors 302 execute instructions 1402 to cause one or more processors 302 to determine whether the payment amount on the check is the same as the payoff amount due for more than one customer product data portion within previously retrieved customer data structure 1404. In one or more embodiments, one or more processors 302 execute instructions 1202 to identify all customer product data portions within previously retrieved customer data structure 1404 that have a payoff amount due that is the same as the payment amount on the check provided by the payment amount data field of the check data.

In the case where the payment amount on the check is the same as the payoff amount due for more than one customer product data portion within previously retrieved customer data structure 1404, one or more processors 302 would determine that the payment amount on the check is equal to the payoff amount due on more than one product of enterprise 800. In the case where the payment amount on the check is equal to the payoff amount due for only one customer product data portion within previously retrieved customer data structure 1404, one or more processors 302 would determine that the payment amount on the check is equal to the payoff amount due on only one product of enterprise 800.

Returning to FIG. 9B, if it is determined that the payoff amount due on only one product is equal to the payment amount on the check (N at S946), the check is classified (return to S934 as shown in FIG. 9C) and computer-implemented method 900 continues.

For purposes of explanation, consider the situation wherein an employee at location 804 receives a check, scans the check, and sends the check data to one or more enterprise servers 104. Further, let the check correspond to a customer of enterprise 800, let the check be for payoff of a home equity line of credit, and let location 808 be the location for which check payments for home equity lines of credit are processed. In one or more embodiments, customer module 316 may have instructions stored therein, that when executed by one or more processors 302, cause one or more enterprise servers 104 to instruct UI 1112 of enterprise user device 814 to display a message for the representative, “Send the check to location 808.”

In accordance with aspects of the present disclosure, in one or more embodiments, when the name on the check does correspond to a customer of the enterprise (Y at S908), when the customer has more than one product of the enterprise for which the payment amount on the check should be applied (Y at S928), when the payment amount due for any of the products of the customer is not equal to the payment amount on the check (N at S930), the computer-implemented method determines whether a payoff amount for any products is equal to the payment amount on the check. If a payoff amount for any products is equal to the payment amount on the check (Y at S944), the computer-implemented method determines whether the payoff amount on more than one product is equal to the payment amount on the check. In one or more of these embodiments, if a payoff amount for only one product is equal to the payment amount on the check (N at S946), the computer-implemented method then identifies a check processing destination, from a plurality check processing destinations of the enterprise, which corresponds to the one product that has a payoff amount that is equal to the payment amount on the check. In one or more of these embodiments, the computer-implemented method then generates a check processing destination message signal that causes a user device of an employee of the enterprise to display a message to forward the check to the check processing destination (S940).

With respect to the check processing destination discussed above, for purposes of discussion only, consider the example enterprise, called Company, discussed above. Further, consider an example situation, wherein Frank Doe sends a check to Company, wherein Frank Doe has a car loan from Company with a monthly payment amount due of $643.22 and a payoff amount of $12312.15, wherein Frank Doe also has a credit card from Company with a monthly payment amount due of $35 and payoff amount of $620.00. However, in this example situation, let the check have a payment amount of $620.00, but not have any information that identifies which Company product for which the payment amount of the check is to be applied. In this example situation, a Company employee at the Blackfield location would receive the check and scan the check. The computer-implemented method would: 1) determine that Frank Doe has a credit card with Company and a car loan with Company; 2) determine that the credit card has a payment amount due that is not equal to the payment amount on the check; 3) determine that the car loan has a payment amount due that is not equal to the payment amount on the check; 4) determine that only the payoff amount of the credit card is equal to the payment amount on the check, and therefore determine that the payment amount of the check should be applied to the credit card; 5) determine that credit card checks are to be processed at the Whitefield Branch; and 6) cause a display on an enterprise user device of the employee of the Company to display a message, “Forward Frank Doe's check to Whitefield Branch.” In this manner, the employee would not need to waste time by contacting each of the Redfield and Greenfield Branches to determine whether they should process Frank Doe's check.

Returning to FIG. 9B, if it is determined that the payment amount due on more than one product is equal to the payment amount on the check (Y at S946), a contact customer message signal is generated (S948 as shown in FIG. 9D). For example, returning to FIG. 3, one or more processors 302 may execute instructions in customer module 316 to cause one or more processors 302 to generate a contact customer message signal.

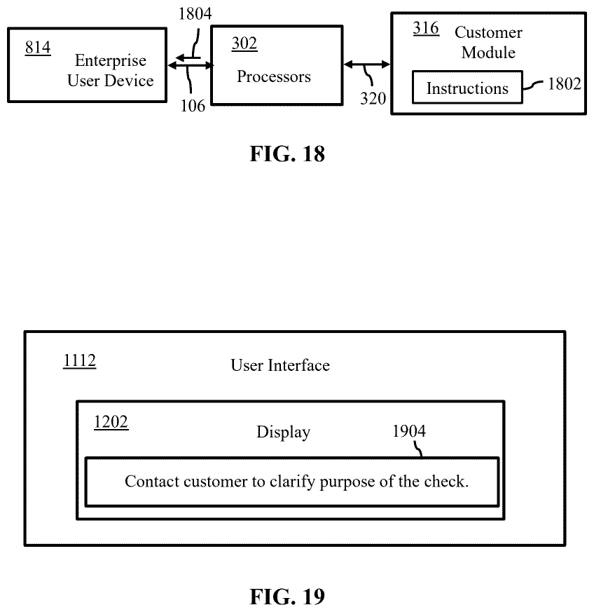

Returning to FIG. 9C, after a contact customer message signal is generated (S948), the contact customer message signal is transmitted (S950). For example, returning to FIG. 3, one or more processors 302 may execute instructions in customer module 316 to cause one or more processors 302 to transmit the contact customer message signal. This will be described in greater detail with reference to FIG. 18.

FIG. 18 illustrates a block diagram of one or more processors 302, customer module 316, and enterprise user device 814 for transmitting a contact customer message signal in accordance with aspects of the present disclosure. Customer module 316 includes instructions 1802 stored therein.

As shown in FIG. 18, one or more processors 302 may execute instructions 1802 to cause one or more one or more processors 302 to transmit a contact customer message signal 1804, to enterprise user device 814. This will be described in greater detail with reference to FIG. 11D.

FIG. 11D illustrates a block diagram of enterprise user device 814 receiving contact customer message signal 1804.

As shown in the figure, upon receiving contact customer message signal 1804, system controller 1102 may execute instructions within customer program 1106 to cause system controller 1102 to transmit a display signal 1130 to UI 1112. Display signal 1130 causes UI 1112 to display a contact customer message. This will be described in greater detail with reference to FIG. 19.

FIG. 19 illustrates UI 1112 of enterprise user device 814 displaying a contact customer message in accordance with aspects of the present disclosure. As shown in the figure, display 1302 is displaying a contact customer message 1904.

For purposes of explanation, consider the situation wherein an employee at location 804 receives a check, scans the check, and sends the check data to one or more enterprise servers 104. Further, let the check correspond to a customer of enterprise 800, and let the check have a payment amount that is equal to the payoff of a car lone and the payoff of a credit card. Still further, let the let the check not have any information that identifies which Company product for which the payment amount of the check is to be applied. In one or more embodiments, customer module 316 may have instructions stored therein, that when executed by one or more processors 302, cause one or more enterprise servers 104 to instruct UI 1112 of enterprise user device 814 to display a message for the representative, “Contact ___ to clarify whether the payment amount of the check should be applied to ___ or ___,” wherein the first blank is populated with the name of the customer, the second blank is populated with “your car loan”, and the second blank is populated with “your credit card.”

In accordance with aspects of the present disclosure, in one or more embodiments, when the name on the check does correspond to a customer of the enterprise (Y at S908), when the customer has more than one product of the enterprise for which the payment amount on the check should be applied (Y at S928), when the payment amount due for any of the products of the customer is not equal to the payment amount on the check (N at S930), the computer-implemented method determines whether a payoff amount for any products is equal to the payment amount on the check. If a payoff amount for any products is equal to the payment amount on the check (Y at S944), the computer-implemented method determines whether the payoff amount on more than one product is equal to the payment amount on the check. In one or more of these embodiments, if a payoff amount for more than one product is equal to the payment amount on the check (Y at S946), the computer-implemented method then generates (S948) and then transmits a contact customer message signal that causes a user device of an employee of the enterprise to display a message to contact the customer (S950).

With respect to the check processing destination verification discussed above, for purposes of discussion only, consider the example enterprise, called Company, discussed above. Further, consider an example situation, wherein Stephanie Doe sends a check to Company, wherein Stephanie Doe has a car loan from Company with a monthly payment amount due of $643.22 and a payoff amount of $12312.15, wherein Stephanie Doe also has a credit card from Company with a monthly payment amount due of $35 and payoff amount of $12312.15. However, in this example situation, let the check have a payment amount of $12312.15, but not have any information that identifies which Company product for which the payment amount of the check is to be applied. In this example situation, a Company employee at the Blackfield location would receive the check and scan the check. The computer-implemented method would: 1) determine that Stephanie Doe has a credit card with Company and a car loan with Company; 2) determine that the credit card has a payment amount due that is not equal to the payment amount on the check; 3) determine that the car loan has a payment amount due that is not equal to the payment amount on the check; 4) determine that the payoff amount of the credit card is equal to the payment amount on the check; 5) determine that the payoff amount of the car loan is also equal to the payment amount on the check; and 6) cause a display on an enterprise user device of the employee of the Company to display a message, “Contact Stephanie Doe and determine whether the $12312.15 on the check is to pay off her credit card or to pay off her car loan.” In this manner, the employee would verify the purpose of the check before determining which branch should process Stephanie Doe's check.

Returning to FIG. 9D, after the check processing destination message signal is transmitted (S950), computer-implemented method 900 stops (S952).

Returning to FIG. 9B, if it is determined that the payoff amount due on more than one product is equal to the payment amount on the check (Y at S932), or if it is determined that the payoff amount is not equal to the payment amount on the check (N at S944), it is determined whether the payment date on the check is within a threshold number of days difference from the due date (S954). For example, returning to FIG. 3, one or more processors 302 may execute instructions in customer module 316 to cause one or more processors 302 to determine whether the payment date on the check is within a threshold number of days difference from the due date.

Returning to FIG. 14, in one or more embodiments, one or more processors 302 execute instructions 1402 to cause one or more processors 302 to identify each payment due date for each customer product data portion within previously retrieved customer data structure 1404. In one or more embodiments, one or more processors 302 execute instructions 1202 to determine whether the payment date on the check provided by the date data field of the check data is within a predetermined threshold number of days dₜₕ from the payment due date for each customer product data portion within previously retrieved customer data structure 1404. In one or more embodiments, instructions 1402 may have dₜₕ therein.

In the case where the payment date on the check is within dₜₕ from the payment due date for at least one customer product data portion within previously retrieved customer data structure 1404, one or more processors 302 would determine that the payment due date is within dt days from the payment date on the check. In the case where the payment date on the check is not within dt days from the payment due date for any customer product data portion within previously retrieved customer data structure 1404, one or more processors 302 would determine that the payment due date is within dₜₕ days from the payment date on the check.

Returning to FIG. 9B, if it is determined that the payment date on the check is not within a threshold number of days different from the due date (N at S954), a contact customer message signal is generated (S948 as shown in FIG. 9D), the contact customer message signal is transmitted (S950), and computer-implemented method 900 stops (S952). These processes may be performed in a manner as discussed above (see Y at S946).

For purposes of explanation, consider the situation wherein an employee at location 804 receives a check, scans the check, and sends the check data to one or more enterprise servers 104. Further, let the check correspond to a customer of enterprise 800, let the check have a payment amount that is equal to the payment amount due of a car lone and the payment amount due of a credit card. Still further, let the let the check not have any information that identifies which Company product for which the payment amount of the check is to be applied. In one or more embodiments, customer module 316 may have instructions stored therein, that when executed by one or more processors 302, cause one or more enterprise servers 104 to instruct UI 1112 of enterprise user device 814 to display a message for the representative, “Contact ___ to clarify whether the payment amount of the check should be applied to ___ or ___,” wherein the first blank is populated with the name of the customer, the second blank is populated with “your car loan”, and the second blank is populated with “your credit card.”

In accordance with aspects of the present disclosure, in one or more embodiments, when the name on the check does correspond to a customer of the enterprise (Y at S908), when the customer has more than one product of the enterprise for which the payment amount on the check should be applied (Y at S928), when the payment amount due for any of the products of the customer is equal to the payment amount on the check (N at S930), the computer-implemented method determines whether a payoff amount for any products is equal to the payment amount on the check. If a payoff amount for any products is equal to the payment amount on the check (Y at S944), the computer-implemented method determines whether the payoff amount on more than one product is equal to the payment amount on the check. In one or more of these embodiments, if a payoff amount for more than one product is equal to the payment amount on the check (Y at S946), the computer-implemented method then generates (S948) and transmits a contact customer message signal that causes a user device of an employee of the enterprise to display a message to contact the customer (S950).

With respect to the check processing destination discussed above, for purposes of discussion only, consider the example enterprise, called Company, discussed above. Further, consider an example situation, wherein Dirk Doe sends a check with a payment amount of $326.55 to Company, wherein Dirk Doe has a car loan from Company with a monthly payment amount due of $326.55, and wherein Dirk Doe has a credit card from Company with a monthly payment amount due that is also $326.55. Further, in this example situation, let the car loan payment due date be the 20^{th} of every month, let the credit card payment due date be the 28^{th} of every month, let dₜₕ be three days, and let the payment date on the check be the 12^{th} of the present month. However, in this example situation, let the check not have any information that identifies which Company product the payment amount of the check is to be applied. In this example situation, a Company employee at the Blackfield location would receive the check and scan the check. The computer-implemented method would: 1) determine that Dirk Doe has a credit card with Company and a car loan with Company; 2) determine that the credit card has a payment amount due that is equal to the payment amount on the check and that the car loan has a payment amount due that is equal to the payment amount on the check; 3) determine that the car loan has a payment due date that is not within dₜₕ of the payment date on the check, 4) determine that the credit card has a payment due date that is not within dₜₕ of the payment date on the check; and 5) cause a display on an enterprise user device of the employee of the Company to display a message, “Contact Dirk Doe and determine whether the $326.55 on the check is to pay his credit card monthly payment or to pay his car loan monthly payment.” In this manner, the employee would verify the purpose of the check before determining which branch should process Dirk Doe's check.

Returning to FIG. 9D, after the check processing destination message signal is transmitted (S950), computer-implemented method 900 stops (S952).

Returning to FIG. 9B, if it is determined that the payment date on the check is within a threshold number of days difference from the due date (Y at S954), it is determined whether the payment date on the check is within a threshold number of days different from the due date of more than one product (S956). For example, returning to FIG. 3, one or more processors 302 may execute instructions in customer module 316 to cause one or more processors 302 to determine whether the payment date on the check is within a threshold number of days different from the due date of more than one product.

Returning to FIG. 14, in one or more embodiments, one or more processors 302 execute instructions 1402 to cause one or more processors 302 to determine whether the payment date on the check is within a predetermined threshold number of days dₜₕ from the payment due date for more than one customer product data portion within previously retrieved customer data structure 1404. In one or more embodiments, one or more processors 302 execute instructions 1202 to identify all customer product data portions within previously retrieved customer data structure 1404 that have a payment due date that is within dₜₕ days from the payment date on the check provided by the date data field of the check data.

In the case where the payment date on the check is within dₜₕ from the payment due date for more than one customer product data portion within previously retrieved customer data structure 1404, one or more processors 302 would determine that the payment date on the check is within dₜₕ days from the payment due date on more than one product of enterprise 800. In the case where the payment date on the check is within dₜₕ days from the payment due date for only one customer product data portion within previously retrieved customer data structure 1404, one or more processors 302 would determine that the payment date on the check is within dt days from the payment due date on only one product of enterprise 800.

Returning to FIG. 9B, if it is determined that the payment date on the check is within a threshold number of days different from the due date of only one product (N at S956), the check is classified (return to S934 as shown in FIG. 9C) and computer-implemented method 900 continues.

For purposes of explanation, consider the situation wherein an employee at location 804 receives a check, scans the check, and sends the check data to one or more enterprise servers 104. Further, let the check correspond to a customer of enterprise 800, let the check be for a monthly payment of a home equity line of credit, and let location 808 be the location for which check payments for home equity lines of credit are processed. In one or more embodiments, customer module 316 may have instructions stored therein, that when executed by one or more processors 302, cause one or more enterprise servers 104 to instruct UI 1112 of enterprise user device 814 to display a message for the representative, “Send the check to location 808.”

In accordance with aspects of the present disclosure, in one or more embodiments, when the name on the check does correspond to a customer of the enterprise (Y at S908), when the customer has more than one product of the enterprise for which the payment amount on the check should be applied (Y at S928): and 1) when the payment amount due for any of the products of the customer is not equal to the payment amount on the check (N at S930), when a payoff amount for any products is not equal to the payment amount on the check (N at S944); or 2) when the payment amount due for any of the products of the customer is equal to the payment amount on the check (Y at S930), when more than one product of the customer has a payment amount due that is equal to the payment amount on the check (Y at S932), the computer-implemented method determines whether the payment date on the check is within a predetermined threshold dₜₕ days from a due date of a product. In one or more of these embodiments, if the payment date on the check is within dₜₕ days from the due date (Y at S954), the computer-implemented method then determines whether the payment date on the check is within dₜₕ days of a due date of more than one product (S956). In one or more of these embodiments, if the payment date on the check is within dₜₕ days from the due date of a single product, the computer-implemented method then identifies a check processing destination, from a plurality check processing destinations of the enterprise, that corresponds to the one product that has a due date that is within dₜₕ days of the payment date on the check. In one or more of these embodiments, the computer-implemented method then generates a check processing destination message signal that causes a user device of an employee of the enterprise to display a message to forward the check to the check processing destination (S940).

With respect to the check processing destination discussed above, for purposes of discussion only, consider the example enterprise, called Company, discussed above. Further, consider an example situation, wherein Jason Doe sends a check to Company, wherein Jason Doe has a car loan from Company with a monthly payment amount due of $412.76, and wherein Jason Doe has a credit card from Company with a monthly payment amount due that is also $412.76. Further, in this example situation, let the car loan payment due date be the 15^{th} of every month, let the credit card payment due date be the 28^{th} of every month, let dₜₕ be three days, and let the payment date on the check be the 13^{th} of the present month. However, in this example situation, let the check not have any information that identifies which Company product the payment amount of the check is to be applied. In this example situation, a Company employee at the Blackfield location would receive the check and scan the check. The computer-implemented method would: 1) determine that Jason Doe has a credit card with Company and a car loan with Company; 2) determine that the credit card has a payment amount due that is equal to the payment amount on the check and that the car loan has a payment amount due that is equal to the payment amount on the check; 3) determine that only the car loan has a payment due date that is within dₜₕ of the payment date on the check, and therefore determine that the payment amount of the check should be applied to the car loan; 5) determine that car loan checks are to be processed at the Redfield Branch; and 6) cause a display on an enterprise user device of the employee of the Company to display a message, “Forward Jason Doe's check to Redfield Branch.” In this manner, the employee would not need to waste time by contacting each of the Whitefield and Greenfield Branches to determine whether they should process Jason Doe's check.

Returning to FIG. 9B, if it is determined that the payment date on the check is within a threshold number of days different from the payment due date of more than one product (Y at S956), it is determined whether the payment date on the check is the same as a due date of a product (S958). For example, returning to FIG. 3, one or more processors 302 may execute instructions in customer module 316 to cause one or more processors 302 to determine whether the payment date on the check is the same as a payment due date of a product.

Returning to FIG. 14, in one or more embodiments, one or more processors 302 execute instructions 1402 to cause one or more processors 302 to determine whether the payment date on the check is the same as the payment due date for at least one customer product data portion within previously retrieved customer data structure 1404. In one or more embodiments, one or more processors 302 execute instructions 1202 to identify all customer product data portions within previously retrieved customer data structure 1404 that have a payment due date that is the same as the payment date on the check provided by the date data field of the check data.

In the case where the payment date on the check is the same as the payment due date for at least one customer product data portion within previously retrieved customer data structure 1404, one or more processors 302 would determine that the payment date on the check is the same as the payment due date of at least one product of enterprise 800. In the case where the payment date on the check is not the same as the payment due date for any customer product data portion within previously retrieved customer data structure 1404, one or more processors 302 would determine that the payment date on the check is not the same as the payment due date for any product of enterprise 800.

Returning to FIG. 9B, if it is determined that the payment date on the check is not equal to the due date of a product (N at S958), it is determined whether payments for products are past due for respective product payment due dates (S960 as shown in FIG. 9E). For example, returning to FIG. 3, one or more processors 302 may execute instructions in customer module 316 to cause one or more processors 302 to determine whether payments for products are past due for respective product due dates.

Returning to FIG. 14, in one or more embodiments, one or more processors 302 execute instructions 1402 to cause one or more processors 302 to determine whether any customer product data portion within previously retrieved customer data structure 1404 includes a payment late data portion that indicates that the payment amount due for the enterprise product provided by the enterprise that is associated with the product data structure, and for which the customer is using, has not been paid by the payment due date identified in payment due date data portion. In one or more embodiments, one or more processors 302 execute instructions 1202 to identify all customer product data portions within previously retrieved customer data structure 1404 that have a payment late data portion that indicates that the payment amount due for the enterprise product has not been paid by the payment due date identified in payment due date data portion.

In the case where a payment late data portion indicates that the payment amount due for the enterprise product provided by the enterprise has not been paid by the payment due date identified in payment due date data portion for at least one customer product data portion within previously retrieved customer data structure 1404, one or more processors 302 would determine that the payment due has not been received by the payment due date for at least one enterprise product of the customer. In the case where no payment late data portion indicates that the payment amount due for the enterprise product provided by the enterprise has not been paid by the payment due date identified in payment due date data portion for at least one customer product data portion within previously retrieved customer data structure 1404, one or more processors 302 would determine that the payment due has been received by the payment due date for all enterprise products of the customer.

Returning to FIG. 9E, if it is determined that payments for products are past due for respective product due dates (Y at S960), the product for which payment is furthest past due is identified (S962). For example, returning to FIG. 3, one or more processors 302 may execute instructions in customer module 316 to cause one or more processors 302 to identify the product for which payment is furthest past due.

Returning to FIG. 14, in one or more embodiments, one or more processors 302 execute instructions 1402 to cause one or more processors 302 to compare all the customer product data portions within previously retrieved customer data structure 1404 that include a payment late data portion having an amount of days for which payment has not been received by the payment due date identified in payment due date data portion. In one or more embodiments, one or more processors 302 execute instructions 1402 to cause one or more processors 302 to identify the customer product data portion within previously retrieved customer data structure 1404 that has a payment late data portion having the largest amount of days for which payment has not been received by the payment due date identified in payment due date data portion as being the enterprise product that of the customer that is furthest past due.

Returning to FIG. 9E, after the product for which payment is furthest past due is identified (S962), the check is classified (return to S934 as shown in FIG. 9C) and computer-implemented method 900 continues.

For purposes of explanation, consider the situation wherein an employee at location 804 receives a check, scans the check, and sends the check data to one or more enterprise servers 104. Further, let the check correspond to a customer of enterprise 800, let the customer have a home equity line of credit with the company having a monthly payment that is late, let the customer have a home loan with the company having a monthly payment that is late, let the customer have a car loan with the company having a monthly payment that is late. Still further, in this example, let the car loan for the customer be the most late. Finally, in this example, let location 806 be the location for which check payments for automobile loans are processed. In one or more embodiments, customer module 316 may have instructions stored therein, that when executed by one or more processors 302, cause one or more enterprise servers 104 to instruct UI 1112 of enterprise user device 814 to display a message for the representative, “Send the check to location 806.”

In accordance with aspects of the present disclosure, in one or more embodiments, when the name on the check does correspond to a customer of the enterprise (Y at S908), when the customer has more than one product of the enterprise for which the payment amount on the check should be applied (Y at S928): and 1) when the payment amount due for any of the products of the customer is not equal to the payment amount on the check (N at S930), when a payoff amount for any products is not equal to the payment amount on the check (N at S944); or 2) when the payment amount due for any of the products of the customer is equal to the payment amount on the check (Y at S930), when more than one product of the customer has a payment amount due that is equal to the payment amount on the check (Y at S932), when the payment date on the check is within a predetermined threshold dt days from a due date of a product (Y at S954), when the payment date on the check is within dₜₕ days of a due date of more than one product (Y at S956), the computer-implemented method determines whether the payment date on the check is the same as a due date of any product. In one or more embodiments, if the payment date on the check is not equal to a due date of any product (N at S958), the computer-implemented method determines whether payments for any product are late. In one or more embodiments, if payments for any product are late (Y at S962), the computer-implemented method identifies the product for which payment is the furthest late. The computer-implemented method then identifies a check processing destination, from a plurality check processing destinations of the enterprise, which corresponds to the one product for which payment is furthest late (S962). In one or more of these embodiments, the computer-implemented method then generates a check processing destination message signal that causes a user device of an employee of the enterprise to display a message to forward the check to the check processing destination (S940).

With respect to the check processing destination discussed above, for purposes of discussion only, consider the example enterprise, called Company, discussed above. Further, consider an example situation, wherein Kathy Doe sends a check to Company, wherein Kathy Doe has a car loan from Company with a payment due date on the 1st of every month, and wherein Kathy Doe also has a credit card from Company with a payment due date on the 4th of every month, and let dₜₕ be 5 days. Further, in this example situation, let the payment date on the check be the 6th day of the current month, and the monthly payment for the car loan and the credit card have both been paid. However, in this example situation, let the check not have any information that identifies which Company product the payment amount of the check is to be applied. In this example situation, let a Company employee at the Blackfield location receive the check on the 15th day of the current month and scan the check. The computer-implemented method would: 1) determine that Kathy Doe has a credit card with Company and a car loan with Company; 2) determine that the due date of the credit card payment is within dₜₕ of the payment date on the check and that the due date of the car loan is within dₜₕ of the payment date on the check; 3) determine that the due date of the credit card payment is not equal to the payment date on the check and that the due date of the car loan payment is not equal to the payment date on the check; 4) determine that the car loan payment is not late; 5) determine that the credit card payment is 11 days late; 6) determine that the car loan payment is most late, and therefore determine that the payment amount of the check should be applied to the car loan; 7) determine that car loan checks are to be processed at the Redfield Branch; and 8) cause a display on an enterprise user device of the employee of the Company to display a message, “Forward Kathy Doe's check to Redfield Branch.” In this manner, the employee would not need to waste time by contacting each of the Whitefield and Greenfield Branches to determine whether they should process Kathy Doe's check.

Returning to FIG. 9E, if it is determined that no payments for products are past due for respective product due dates (N at S960), the product for which payment is most recently due is identified (S964). For example, returning to FIG. 3, one or more processors 302 may execute instructions in customer module 316 to cause one or more processors 302 to identify the product for which payment is most recently due.

Returning to FIG. 14, in one or more embodiments, one or more processors 302 execute instructions 1402 to cause one or more processors 302 to identify every payment due date from every respective payment due date data portion of the respective customer product data portions within previously retrieved customer data structure 1404. In one or more embodiments, one or more processors 302 execute instructions 1402 to cause one or more processors 302 to identify the customer product, corresponding data portion within previously retrieved customer data structure 1404 that has payment due date data portion that has a due date that is closest to the payment date on the check, as the product for which payment is most recently due.

Returning to FIG. 9E, after the product for which payment is most recently due is identified (S964), the check is classified (return to S934 as shown in FIG. 9C) and computer-implemented method 900 continues.

For purposes of explanation, consider the situation wherein an employee at location 804 receives a check, scans the check, and sends the check data to one or more enterprise servers 104. Further, let the check correspond to a customer of enterprise 800, let the customer have a home equity line of credit with the company having a monthly payment that is not late, let the customer have a home loan with the company having a monthly payment that is not late, let the customer have a car loan with the company having a monthly payment that is not late. Still further, in this example, let the car loan for the customer be the due in the nearest amount of time. Finally, in this example, let location 806 be the location for which check payments for automobile loans are processed. In one or more embodiments, customer module 316 may have instructions stored therein, that when executed by one or more processors 302, cause one or more enterprise servers 104 to instruct UI 1112 of enterprise user device 814 to display a message for the representative, “Send the check to location 806.”

In accordance with aspects of the present disclosure, in one or more embodiments, when the name on the check does correspond to a customer of the enterprise (Y at S908), when the customer has more than one product of the enterprise for which the payment amount on the check should be applied (Y at S928): and 1) when the payment amount due for any of the products of the customer is not equal to the payment amount on the check (N at S930), when a payoff amount for any products is not equal to the payment amount on the check (N at S944); or 2) when the payment amount due for any of the products of the customer is equal to the payment amount on the check (Y at S930), when more than one product of the customer has a payment amount due that is equal to the payment amount on the check (Y at S932), when the payment date on the check is within a predetermined threshold dt days from a due date of a product (Y at S954), when the payment date on the check is within dₜₕ days of a due date of more than one product (Y at S956), the computer-implemented method determines whether the payment date on the check is the same as a due date of any product. In one or more embodiments, if the payment date on the check is the same as a due date of any product (N at S958), the computer-implemented method determines whether payments for any product are late. In one or more embodiments, if payments for any products are not late (N at S960), the computer-implemented method identifies the product for which due date for payment is closest to the payment date on the check (S964). The computer-implemented method then identifies a check processing destination, from a plurality check processing destinations of the enterprise, which corresponds to the one product for which the payment due date payment is closest to the payment date on the check. In one or more of these embodiments, the computer-implemented method then generates a check processing destination message signal that causes a user device of an employee of the enterprise to display a message to forward the check to the check processing destination (S940).

With respect to the check processing destination discussed above, for purposes of discussion only, consider the example enterprise, called Company, discussed above. Further, consider an example situation, wherein Tom Doe sends a check to Company, wherein Tom Doe has a car loan from Company with a payment due date on the 15th of every month, wherein Tom Doe also has a credit card from Company with a payment due date on the 18th of every month, and wherein dₜₕ is 5 days. Further, in this example situation, let the payment date on the check be the 9th day of the current month, and the monthly payment for the car loan and the credit card have not yet been paid. However, in this example situation, let the check not have any information that identifies which Company product the payment amount of the check is to be applied. In this example situation, let a Company employee at the Blackfield location receive the check on the 14th day of the current month and scan the check. The computer-implemented method would: 1) determine that Tom Doe has a credit card with Company and a car loan with Company; 2) determine that the due date of the credit card payment is within dₜₕ of the payment date on the check and that the due date of the car loan is within dₜₕ of the payment date on the check; 3) determine that the due date of the credit card payment is not equal to the payment date on the check and that the due date of the car loan payment is not equal to the payment date on the check; 4) determine that the credit card payment and the car loan payment are not late; 5) determine that the car loan due date is closer to the date of the check than credit card payment due date is to the date of the check, and therefore determine that the payment amount of the check should be applied to the car loan; 6) determine that car loan checks are to be processed at the Redfield Branch; and 7) cause a display on an enterprise user device of the employee of the Company to display a message, “Forward Tom Doe's check to Redfield Branch.” In this manner, the employee would not need to waste time by contacting each of the Whitefield and Greenfield Branches to determine whether they should process Tom Doe's check.

Returning to FIG. 9B, if it is determined that the payment date on the check is the same as a due date of a product (Y at S958), it is determined whether the payment date on the check is the same as a due date of more than one product (S966). For example, returning to FIG. 3, one or more processors 302 may execute instructions in customer module 316 to cause one or more processors 302 to determine whether the payment date on the check is the same as a due date of more than one product.

Returning to FIG. 14, in one or more embodiments, one or more processors 302 execute instructions 1402 to cause one or more processors 302 to determine whether the payment date on the check is within is the same as the payment due date for more than one customer product data portion within previously retrieved customer data structure 1404. In one or more embodiments, one or more processors 302 execute instructions 1202 to identify all customer product data portions within previously retrieved customer data structure 1404 that have a payment due date that is the same as the payment date on the check provided by the date data field of the check data.

In the case where the payment date on the check is the same as the payment due date for more than one customer product data portion within previously retrieved customer data structure 1404, one or more processors 302 would determine that the payment date on the check is the same as the payment due date on more than one product of enterprise 800. In the case where the payment date on the check is the same as the payment due date for only one customer product data portion within previously retrieved customer data structure 1404, one or more processors 302 would determine that the payment date on the check is the same as the payment due date on only one product of enterprise 800.

Returning to FIG. 9B, if it is determined that payment date on the check is the same as a due date of only one product (N at S966), the check is classified (return to S934 as shown in FIG. 9C) and computer-implemented method 900 continues.

For purposes of explanation, consider the situation wherein an employee at location 804 receives a check, scans the check, and sends the check data to one or more enterprise servers 104. Further, let the check correspond to a customer of enterprise 800, let the payment date on the check be the same as a payment due date for only one product of the customer—a home loan, and let location 804 be the location for which check payments for home loans are processed. In one or more embodiments, customer module 316 may have instructions stored therein, that when executed by one or more processors 302, cause one or more enterprise servers 104 to instruct UI 1112 of enterprise user device 814 to display a message for the representative, “Send the check to location 804.”

In accordance with aspects of the present disclosure, in one or more embodiments, when the name on the check does correspond to a customer of the enterprise (Y at S908), when the customer has more than one product of the enterprise for which the payment amount on the check should be applied (Y at S928): and 1) when the payment amount due for any of the products of the customer is not equal to the payment amount on the check (N at S930), when a payoff amount for any products is not equal to the payment amount on the check (N at S944); or 2) when the payment amount due for any of the products of the customer is equal to the payment amount on the check (Y at S930), when more than one product of the customer has a payment amount due that is equal to the payment amount on the check (Y at S932), when the payment date on the check is within a predetermined threshold dₜₕ days from a due date of a product (Y at S954), when the payment date on the check is within dₜₕ days of a due date of more than one product (Y at S956), when the payment date of the check is the same as the payment due date of at least one product (Y at S958), the computer-implemented method determines whether the payment date on the check is the same as a due date of more than one product (S966). In one or more embodiments, if the payment date on the check is the same as a due date of only one product (N at S966), the computer-implemented method identifies a check processing destination, from a plurality check processing destinations of the enterprise, which corresponds to the one product for which the payment due date payment equal to the payment date on the check. In one or more of these embodiments, the computer-implemented method then generates a check processing destination message signal that causes a user device of an employee of the enterprise to display a message to forward the check to the check processing destination (S940).

With respect to the check processing destination discussed above, for purposes of discussion only, consider the example enterprise, called Company, discussed above. Further, consider an example situation, wherein Angie Doe sends a check to Company, wherein Angie Doe has a car loan from Company with a payment due date on the 15th of every month, wherein Angie Doe also has a home loan from Company with a payment due date on the 18th of every month, and wherein dt is 5 days. Further, in this example situation, let the payment date on the check be the 15th day of the current month, and the monthly payment for the car loan and the home loan have not yet been paid. However, in this example situation, let the check not have any information that identifies which Company product the payment amount of the check is to be applied. In this example situation, let a Company employee at the Blackfield location receive the check and scan the check. The computer-implemented method would: 1) determine that Angie Doe has a car loan with Company and a home loan with Company; 2) determine that the due date of the car loan payment is within dₜₕ of the payment date on the check and that the due date of the home loan payment is within dₜₕ of the payment date on the check; 3) determine that the due date of the home loan payment is equal to the payment date on the check and that the due date of the car loan payment is not equal to the payment date on the check, and therefore determine that the payment amount of the check should be applied to the home loan; 4) determine that home loan checks are to be processed at the Greenfield Branch; and 5) cause a display on an enterprise user device of the employee of the Company to display a message, “Forward Angie Doe's check to Greenfield Branch.” In this manner, the employee would not need to waste time by contacting each of the Whitefield and Redfield Branches to determine whether they should process Angie Doe's check.

Returning to FIG. 9B, if it is determined that payment date on the check is the same as a due date of more than one product (Y at S966),, a contact customer message signal is generated (S948 as shown in FIG. 9D), the contact customer message signal is transmitted (S950), and computer-implemented method 900 stops (S952). These processes may be performed in a manner as discussed above (see Y at S946).

For purposes of explanation, consider the situation wherein an employee at location 804 receives a check, scans the check, and sends the check data to one or more enterprise servers 104. Further, let the check correspond to a customer of enterprise 800, let the check have a payment amount that is equal to the payment amount due of a car lone and the payment amount due of a credit card, and let the payment date on the check be same as the due date of the car loan monthly payment and the due date of the credit card monthly payment. Still further, let the let the check not have any information that identifies which Company product for which the payment amount of the check is to be applied. In one or more embodiments, customer module 316 may have instructions stored therein, that when executed by one or more processors 302, cause one or more enterprise servers 104 to instruct UI 1112 of enterprise user device 814 to display a message for the representative, “Contact ___ to clarify whether the payment amount of the check should be applied to ____ or ____” wherein the first blank is populated with the name of the customer, the second blank is populated with “your car loan”, and the second blank is populated with “your credit card.”

In accordance with aspects of the present disclosure, in one or more embodiments, when the name on the check does correspond to a customer of the enterprise (Y at S908), when the customer has more than one product of the enterprise for which the payment amount on the check should be applied (Y at S928): and 1) when the payment amount due for any of the products of the customer is not equal to the payment amount on the check (N at S930), when a payoff amount for any products is not equal to the payment amount on the check (N at S944); or 2) when the payment amount due for any of the products of the customer is equal to the payment amount on the check (Y at S930), when more than one product of the customer has a payment amount due that is equal to the payment amount on the check (Y at S932), when the payment date on the check is within a predetermined threshold dₜₕ days from a due date of a product (Y at S954), when the payment date on the check is within du days of a due date of more than one product (Y at S956), when the payment date of the check is the same as the payment due date of at least one product (Y at S958), the computer-implemented method determines whether the payment date on the check is the same as a due date of more than one product (S 966). In one or more embodiments, if the payment date on the check is the same as a due date of more than one product (Y at S966), the computer-implemented method generates (S948) and transmits a contact customer message signal that causes a user device of an employee of the enterprise to display a message to contact the customer (S950).

With respect to the check processing destination discussed above, for purposes of discussion only, consider the example enterprise, called Company, discussed above. Further, consider an example situation, wherein Eric Doe sends a check to Company, wherein Eric Doe has a car loan from Company with a payment due date on the 15th of every month and a payment amount due of $420.00, wherein Eric Doe also has a credit card from Company with a payment due date on the 15th of every month and a payment amount due of $420.00, wherein the payment date of the check is the 15th of the current month, and wherein the payment amount on the check is $420.00. However, in this example situation, let the check not have any information that identifies which Company product the payment amount of the check is to be applied. In this example situation, let a Company employee at the Blackfield location receive the check and scan the check. The computer-implemented method would: 1) determine that Eric Doe has a car loan with Company and a credit card with Company; 2) determine that the due date of the car loan payment is the same the payment date on the check and that the due date of the credit card payment is also the same as the payment date on the check; 3) determine that payment amount due on the credit card is equal to the payment amount on the check and that the payment amount due on the car loan is also equal to the payment amount on the check; and 5) cause a display on an enterprise user device of the employee of the Company to display a message, “Contact Eric Doe and determine whether the $420.00 on the check is to pay his credit card monthly payment or to pay his car loan monthly payment.” In this manner, the employee would verify the purpose of the check before determining which branch should process Eric Doe's check.

Returning to FIG. 9D, after the check processing destination message signal is transmitted (S950), computer-implemented method 900 stops (S952).

The foregoing description of various preferred embodiments have been presented for purposes of illustration and description. It is not intended to be exhaustive or to limit the disclosure to the precise forms disclosed, and obviously many modifications and variations are possible in light of the above teaching. The example embodiments, as described above, were chosen and described in order to enable others skilled in the art to best utilize the disclosure in various embodiments and with various modifications as are suited to the particular use contemplated. It is intended that the scope of the disclosure be defined by the claims appended hereto.

1. A server computing system, comprising:
one or more processors; and
a non-transitory memory, coupled to the one or more processors, and having a set of instructions of computer-executable program code stored therein, which when executed by the one or more processors, cause the one or more processors to perform operations including:
storing, in the non-transitory memory via the one or more processors, one or more data structures that include a respective customer name data portion, a plurality of respective product data portions including a respective payment amount due data portion, a respective payoff amount due data portion, and a respective payment due date data portion;
analyzing, via the one or more processors, image data associated with a check received by a merchant;
identifying, via the one or more processors and based on the analysis of the image data, a payment amount of the check;
analyzing, via the one or more processors, one or more the customer data structures when the analyzed image data does not identify at least one of the one or more customer data structures;
classifying, via the one or more processors, the check based on the identified payment amount and the analysis of the one or more customer data structures, as one classification type within a plurality of different classification types, wherein the classifying includes comparing the identified payment amount to at least one of the respective payment amount due data portion and the respective payoff amount due data portion of at least one of each of the one or more customer data structures;
identifying, via the one or more processors and based on the one classification type, a check processing destination from a plurality of check processing destinations;
generating, via the one or more processors, a check processing destination message signal based on the check processing destination; and
transmitting, via the one or more processors, the check processing destination message signal to a client device to cause display of information related to the check processing destination on a user interface of the client device.

2. The server computing system of claim 1, wherein:
the set of instructions, which when executed by the one or more processors, cause the one or more processors to perform operations further including:
identifying, via the one or more processors, at least one due date, within the analyzed one or more customer data structures, and
identifying, via the one or more processors, a candidate due date of the identified at least one due date,
wherein the classifying the check as the one classification type within the plurality of different classification types is additionally based on the identified candidate due date.

3. The server computing system of claim 2, wherein:
the set of instructions, which when executed by the one or more processors, cause the one or more processors to perform operations further including identifying a payment date on the check from the analyzed image data, and
the classifying the check as the one classification type within the plurality of different classification types is additionally based on the payment date.

4. The server computing system of claim 3, wherein the set of instructions, which when executed by the one or more processors, cause the one or more processors to perform operations further including classifying the check as the one classification type within the plurality of different classification types when the payment date is prior to the identified candidate due date.

5. The server computing system of claim 4, wherein the set of instructions, which when executed by the one or more processors, cause the one or more processors to perform operations further including classifying the check as the one classification type within the plurality of different classification types when the payment date is within a predetermined threshold of days dₜₕ of the identified candidate due date.

6. The server computing system of claim 3, wherein the set of instructions, which when executed by the one or more processors, cause the one or more processors to perform operations further including classifying the check as the one classification type within the plurality of different classification types when the payment date is within a predetermined threshold of days dₜₕ of the identified candidate due date.

7. The server computing system of claim 1, wherein:
the set of instructions, which when executed by the one or more processors, cause the one or more processors to perform operations further including:
identifying, via the one or more processors, at least one payment amount due, within the analyzed one or more customer data structures; and
identifying, via the one or more processors, a candidate payment amount due of the identified at least one payment amount due,
wherein the classifying the check as the one classification type within the plurality of different classification types is additionally based on the identified candidate payment amount due.

8. The server computing system of claim 7, wherein the set of instructions, which when executed by the one or more processors, cause the one or more processors to perform operations further including classifying the check as the one classification type within the plurality of different classification types when the payment amount is the same as the identified candidate payment amount due.

9. The server computing system of claim 1, wherein:
the set of instructions, which when executed by the one or more processors, cause the one or more processors to perform operations further including:
identifying, via the one or more processors, at least one payoff amount due, within the analyzed one or more customer data structures; and
identifying, via the one or more processors, a candidate payoff amount due of the identified at least one payoff amount due,
wherein the classifying the check as the one classification type within the plurality of different classification types is additionally based on the identified candidate payoff amount due.

10. The server computing system of claim 9, wherein the set of instructions, which when executed by the one or more processors, cause the one or more processors to perform operations further including classifying the check as the one classification type within the plurality of different classification types when the payment amount is the same as the identified candidate payoff amount due.

11. The server computing system of claim 1, wherein the set of instructions, which when executed by the one or more processors, cause the one or more processors to perform operations further including:
identifying, via the one or more processors, a name from the analyzed image data;
identifying, via the one or more processors, a at least one respective name of at least one respective customer from the at least one of each of the customer data structures; and
determining, via the one or more processors, whether the name from the analyzed image data corresponds to one of the at least one respective name of the at least one respective customer.

12. The server computing system of claim 11, wherein the set of instructions, which when executed by the one or more processors, cause the one or more processors to perform operations further including:
generating, via the one or more processors, a return to sender signal when the name from the analyzed image data does not correspond to one of the at least one respective name of the at least one respective customer; and
transmitting, via the one or more processors, the return to sender signal to a client device to cause display of a return to sender message on a user interface of the client device.

13. The server computing system of claim 11, wherein the set of instructions, which when executed by the one or more processors, cause the one or more processors to perform operations further including identifying the name from a name data field portion of the analyzed image data.

14. The server computing system of claim 13, wherein the set of instructions, which when executed by the one or more processors, cause the one or more processors to perform operations further including:
determining, via the one or more processors, whether a second name is in a memo data field portion of the analyzed image data, when the name from the analyzed image data does not correspond to one of the at least one respective name of the at least one respective customer;
identifying, via the one or more processors, the second name when the second name is in the memo data field portion of the analyzed image data; and
determining, via the one or more processors, whether the second name from the analyzed image data corresponds to one of the at least one respective name of the at least one respective customer.

15. The server computing system of claim 14, wherein the set of instructions, which when executed by the one or more processors, cause the one or more processors to perform operations further including:
generating, via the one or more processors, a return to sender signal when the name from the analyzed image data does not correspond to one of the at least one respective name of the at least one respective customer, when the second name is not in the memo data field portion of the analyzed image data, and when the second name is in the memo data field portion of the analyzed data but does not correspond to one of the at least one respective name of the at least one respective customer; and
transmitting, via the one or more processors, the return to sender signal to a client device to cause display of a return to sender message on a user interface of the client device.

16. The server computing system of claim 1, wherein:
the set of instructions, which when executed by the one or more processors, cause the one or more processors to perform operations further including:
identifying, via the one or more processors, at least one due date, within the analyzed one or more customer data structures;
identifying, via the one or more processors, a candidate due date of the identified at least one due date;
identifying, via the one or more processors, at least one payment amount due, within the analyzed one or more customer data structures; and
identifying, via the one or more processors, a candidate payment amount due of the identified at least one payment amount due,
wherein the classifying the check as the one classification type within the plurality of different classification types is additionally based on the identified candidate due date and the identified candidate payment amount due.

17. The server computing system of claim 16, wherein the set of instructions, which when executed by the one or more processors, cause the one or more processors to perform operations further including:
identifying, via the one or more processors, at least one payoff amount due, within the analyzed one or more customer data structures; and
identifying, via the one or more processors, a candidate payoff amount due of the identified at least one payoff amount due.

18. The server computing system of claim 17, wherein the classifying the check as the one classification type within the plurality of different classification types is additionally based on the identified candidate payoff amount due.

19. A computer-implemented method of operating a system for implementation by one or more processors of a server computing system, the computer-implemented method comprising:
storing, in the non-transitory memory via the one or more processors, one or more data structures that include a respective customer name data portion, a plurality of respective product data portions including a respective payment amount due data portion, a respective payoff amount due data portion, and a respective payment due date data portion;
analyzing, via the one or more processors executing a set of instructions of computer-executable program code stored in the non-transitory memory coupled to the one or more processors, image data associated with a check received by a merchant;
identifying, via the one or more processors and based on the analysis of the image data, a payment amount of the check;
analyzing, via the one or more processors, the customer data structures when the analyzed image data does not identify at least one of the one or more customer accounts;
classifying, via the one or more processors, the check, based on the identified payment amount and the analysis of the customer account data structures, as one classification type within a plurality of different classification types, wherein the classifying includes comparing the identified payment amount to at least one of the respective payment amount due data portion and the respective payoff amount due data portion of at least one of each of the one or more customer data structures;
identifying, via the one or more processors and based on the one classification type, a check processing destination from a plurality of check processing destinations;
generating, via the one or more processors, a check processing destination message signal based on the check processing destination; and
transmitting, via the one or more processors, the check processing destination message signal to a client device to cause display of information related to the check processing destination on a user interface of the client device.

20. A computer program product comprising at least one non-transitory computer readable medium having a set of instructions of computer-executable program code, which when executed by one or more processors of an enterprise computer server system, cause the one or more processors to perform a computer-implemented method comprising:
storing, in the non-transitory computer readable medium via the one or more processors, one or more data structures that include a respective customer name data portion, a plurality of respective product data portions including a respective payment amount due data portion, a respective payoff amount due data portion, and a respective payment due date data portion;
analyzing, via the one or more processors, image data associated with a check received by a merchant;
identifying, via the one or more processors and based on the analysis of the image data, a payment amount of the check;
analyzing, via the one or more processors, the customer data structures when the analyzed image data does not identify at least one of the one or more customer accounts;
classifying, via the one or more processors, the check, based on the identified payment amount and the analysis of the customer data structures, as one classification type within a plurality of different classification types, wherein the classifying includes comparing the identified payment amount to at least one of the respective payment amount due data portion and the respective payoff amount due data portion of at least one of each of the one or more customer data structures;
identifying, via the one or more processors and based on the one classification type, a check processing destination from a plurality of check processing destinations;
generating, via the one or more processors, a check processing destination message signal based on the check processing destination; and
transmitting, via the one or more processors, the check processing destination message signal to a client device to cause display of information related to the check processing destination on a user interface of the client device.
